(19) United States
(12) Patent Application Publication
(10) Pub. No.: US 2005/0279200 A1
(43) Pub. Date: Dec. 22, 2005

(54) Miter gauge, jig and fixture improvements

(76) Inventor: Mark A. Duginske, Merrill, WI (US)

Correspondence Address: QUARLES & BRADY LLP, 411 E. WISCONSIN AVENUE, SUITE 2040, MILWAUKEE, WI, 53202-4497, US

(21) Appl. No.: 11/158,228

(22) Filed: Jun. 21, 2005

Related U.S. Application Data
(60) Provisional application No. 60/581,798, filed on Jun. 22, 2004.

(51) Int. Cl. B26D 1/14

(52) U.S. Cl. 83/471.3

(57) ABSTRACT

A miter gauge with a machined aluminum head that has a stamped aluminum scale secured in a machined slot. The scale has indicia that facilitate reading the scale including color-coded diamonds, arrow heads and longer lines at key positions. The miter gauge is quickly adjustable to 1/100th of a degree using ordinary shop tools such as a feeler gauge or dial caliper. An optional sled is a platform with two pieces of minitrack on each side and a dado in the middle in which the miter gauge can be secured quickly to a bar on the bottom of the sled that slides in the table saw miter gauge. A flip arm stop design with a removable back allows space for a zero clearance board on the front of an L-shaped fence extrusion. A T-shaped fence extrusion with a built-in zero-clearance board has a modified T-slot with an interlocking minitrack which allows the fence to be extended and secured with a standard bolt without the need for machining.

### CROSS-REFERENCE TO RELATED APPLICATION

This application claims the benefit of U.S. Provisional Patent Application No. 60/581,798 filed on Jun. 22, 2004.

### STATEMENT CONCERNING FEDERALLY SPONSORED RESEARCH OR DEVELOPMENT

Not applicable.

### FIELD OF THE INVENTION

This invention relates to shop-made jigs and fixtures for positioning, aligning, guiding and/or holding a workpiece on metalworking or woodworking machines during a cutting or shaping operation.

### BACKGROUND OF THE INVENTION

U.S. Pat. No. 5,768,966 (the '966 patent) and U.S. Pat. No. 6,880,442 disclose improved jigs and fixtures for aligning, guiding, and/or holding a workpiece as it is worked, for example, as it is cut, drilled, or routed. While the miter gauge disclosed in the '966 patent represents a significant advance in the art, room still exists for improvements, particularly in the following respects:

The machined numerals of the '966 patent, which are very expensive to manufacture because they are individually machined, are wide because of the cutter width and are hard to read.

The bar line and pointer of the '966 patent are adjustable but there is no fine tuning mechanism and the resolution needs improvement.

No miter gauge design has a machined extruded head specially adapted for easy fixturing.

No miter gauge manufactured until now has had adjustable fine angle tuning using ordinary shop tools.

It has been a common practice when working with a table saw for the user to make a sliding sled which is a sliding platform with a runner that fits into the miter slot of the table saw. The sled has the advantage of supporting the board from below as it is advanced into the table saw blade during the saw cut. The sliding sled has the advantage over the miter gauge of providing better support for large boards which can bind even with the miter gauge reversed in the miter slot. The sled is also advantageous for cutting small pieces because these delicate pieces can be clamped to the sled platform and safely moved into the blade.

The sled platform also provides a zero-clearance support under the workpiece preventing tear out and chipping on the bottom of the board. Commercially made sleds are available from Delta, Dubby, Incra, Jointech, and Woodhaven. There is no optional sled design that allows the miter gauge to be secured to a sled platform thus providing the advantages of the miter gauge and the sled in the same unit.

U.S. patent application Ser. No. 10/944,035 has been filed on an improved track and flip stop assembly. Although the improved track and stop assembly of U.S. patent application Ser. No. 10/944,035 has a number of advantages over the '966 patent, there is at least one feature that has room for improvement.

The double T-slot on top of the track of the '966 patent allows a stop to be moved forward to the front T-slot to make room for a zero-clearance fence. A zero-clearance fence is a board that is placed in back of the workpiece and supports the back of the workpiece as it is being cut by the blade, thus preventing tearing or chipping of the workpiece. There is room for improvement regarding the zero clearance fence, stops that can be used with a zero clearance fence and how a zero clearance fence is integrated with a track.

### SUMMARY OF THE INVENTION

The invention provides improvements to a miter gauge and jig and fixture system that make them more accurate and easy to use to cut better quality workpieces.

In one aspect, a miter guide of the invention has a miter head with a miter head angle scale fixed to it and the miter bar has a Vernier angle scale fixed to it. The Vernier scale has a set of indicia positioned at at least three positions that are aligned with a corresponding number of indicia on the miter head angle scale when the miter head is at a 0° position relative to the miter bar. Multiple positions that indicia are aligned improves the resolution accuracy of reading the scales so that angle positions for whole number angles can be set with improved accuracy.

In an especially preferred form, there are at least five positions that are aligned with a corresponding number of indicia on the miter head angle scale when the miter head is at a 0° position relative to the miter bar, for example at the 0 position and 5 and 9 degree position on the miter head angle scale on both sides of 0. Thus, for whole number positions, all five sets of indicia are aligned.

In another preferred aspect, there are distinguishing indicia on the miter head angle scale at the at least three positions that distinguish those positions from other indicia on the miter head angle scale. For example, in the preferred embodiment, there is an arrowhead at the 0 position and diamonds at the two 5 positions, and different colors for the indicia are used, than the colors of some of the other lines. There may also be distinguishing indicia on the miter bar angle scale at the at least three positions that distinguish those positions from other indicia on the miter bar angle scale, for example diamonds, arrows, a longer length of line or different colors for the indicia.

In another preferred form, the miter bar angle scale is adjustably fixed to the miter bar. This enables accurately aligning the Vernier scale to the miter head angle scale in assembly of the miter bar. This may be done, for example, using a microscope.

In another preferred aspect, the Vernier scale is a double Vernier scale having Vernier angle scale markings on both sides of a 0° position. This lends itself particularly well to improved resolution accuracy and to making fractional angle settings on both sides of zero.

In another aspect of the invention, the front face of the miter head has vertically extending edges at opposite ends spaced a certain distance apart so that a fence can be positioned against the front face and angled relative to the front face with one edge of the front face acting as a fulcrum against the fence and the spacing between the other edge and the fence measured and converted to an angle with a certain known relationship between the measured spacing and the angle. For example, if the spacing between the edges is approximately 5.729 inches, each incremental measurement of 0.001 inches on a dial caliper converts to 0.01 degrees.

In this aspect, it is especially useful to provide a ledge spaced a certain distance back from one or both of the edges such that a measurement of the spacing can be made between the ledge and the fence to determine the spacing of the fence from the edge. The ledge establishes the point at which the measurement is made in the widthwise direction, and also can be spaced back 0.1 inches from the front face to make measurements easy.

In this aspect, the fence can be made micro-adjustable in angle relative to the miter head front fact by providing a T-slot in a rear surface of the fence in which heads of bolts that extend through the front surface of the miter head are slidably received, and at least one adjustment screw that extends from the front face of the miter head that can be turned to adjust the angle of the fence to the front face of the miter head.

In another aspect of the invention, the miter bar has holes that extend between the top and bottom surfaces of the miter bar. These enable the miter bar to be secured to a sled platform that supports the workpiece from beneath and slides with the workpiece as it is fed into the cutting tool. A fixture bar can be provided under the sled in alignment with the miter bar that is received in a groove in the sled platform. T-slots can be provided on the sides of the miter bar to facilitate mounting a fence to the sled.

In another aspect, a stop for a jig and fixture system has an arm and a shoe, with the arm attached to the shoe and the shoe extending forwardly and rearwardly of the arm. The shoe has a forward portion and a rearward portion, and the rearward portion is removable from the forward portion. It may be removable with a fastener or by breaking off the rear portion. It is removable so as to make room for a zero clearance fence behind the stop.

In another aspect a track for a jig and fixture system has a generally T-shaped cross-sectional shape, having a first leg with a front side and a rear side and a second leg connected to one end of the first leg at a right angle. The second leg extends forwardly and rearwardly from the first leg and has a top side and a bottom side, and has a longitudinal T-slot on the top side of the second leg. A zero clearance fence can be provided on the front side of the first leg, below the forward portion of the second leg. In this aspect, the track can beneficially be provided with a modified T-slot having a central slot, ledges inside the T-slot adjacent to the central slot that can support the underside of the head of a fastener and angled wing surfaces outward of the ledges. A minitrack can be provided that fits in the modified T-slot with angled surfaces that mate with the angled wing surfaces of the modified T-slot and that has a T-slot to receive the head of a fastener. Two of the T-shaped tracks can be connected by the minitrack to extend the fence.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a miter gauge of the invention positioned in the miter slot as it is used on a table saw.

FIG. 2A is a side cross-sectional view of the miter gauge.

FIG. 2B is an exploded perspective view of the miter gauge.

FIG. 2C is an enlarged exploded perspective view of FIG. 2B.

FIG. 2D is an end view of the miter bar of the miter gauge.

FIG. 2E is an end view of the L-shaped extrusion of the miter gauge head.

FIG. 2F is a perspective view of the Vernier scale holder and with the Vernier scale in place.

FIG. 2G is a perspective view of the of the extrusion of the miter gauge head with the scale in place.

FIG. 2H is an exploded perspective vierw of FIG. 2F showing the Vernier scale holder and the Vernier scale.

FIG. 2I is an exploded perspective of FIG. 2F showing the Vernier scale holder and socket head cap screws which secure it.

FIG. 2J is an exploded perspective of FIG. 2G showing the extrusion of the miter gauge head with the degree scale.

FIG. 2K is a side view of the miter gauge of the invention.

FIG. 2L is a top view of the miter gauge.

FIG. 2M is an end view of the miter gauge.

FIG. 3 is a perspective view of the miter gauge set at a 30 degree angle and positioned in the miter slot as it is used on a table saw with an extruded fence.

FIG. 4 is a top view of the miter gauge of the invention, set at a 30 degree angle, positioned in the miter slot as it is used on a table saw with an extruded fence.

FIG. 5 is an end elevation of the miter gauge as shown in FIG. 4.

FIG. 6A is a top view of the Vernier scale with the miter gauge set at 0 degrees.

FIG. 6B is a top view of the left Vernier scale and the right Vernier scale.

FIG. 7 is an enlargement of FIG. 9.

FIG. 8 is a top view of the Vernier scale with the miter gauge set at 0 degrees shown without distinguishing indicia on the Vernier scale or the miter head angle scale.

FIG. 9 is a top view of the Vernier scale with the miter gauge set at 0 degrees shown with the color-coded diamonds and arrows and resolution lines at plus and minus 5 degrees on the Vernier scale.

FIG. 10 is a top view of the Vernier scale with the miter gauge set at 0 degrees shown with the color-coded diamonds and arrows and without the degree lines opposite the Vernier scale and without the lines on the Vernier scale.

FIG. 11A is a top view of the Vernier scale with the miter gauge set at 22.5 degrees (22.5 degrees on the miter head angle scale is aligned with 0 degrees on the Vernier scale).

FIG. 11B is an enlargement of FIG. 11A.

FIG. 12 is a top view of the Vernier scale with the miter gauge set at 37.3 degrees.

FIG. 13A is a top view of the Vernier scale with the miter gauge set at 1.3 degrees.

FIG. 13B is an enlargement of FIG. 13A.

FIG. 14 is a perspective view of the back of the miter gauge with an extruded track as it is used on a table saw. The dial caliper or the feeler gauge is used to measure the gap between the miter gauge head and the extruded fence.

FIG. 15 is an end view of the miter gauge extrusion shown with a plastic ¼-20 thumb bolt located in a threaded hole.

FIG. 16 is an end view of the miter gauge extrusion shown with a ¼-20 thumb bolt located in a through hole.

FIG. 17 is a perspective view of the back of the extruded L-shaped fence track.

FIG. 18A is an end view of the miter gauge extrusion shown with a plastic ¼-20 socket head set screw located in a threaded hole as it is used to advance the extruded fence track.

FIG. 18B is an end view of the miter gauge extrusion shown with a piece of minitrack replacing the extruded fence track shown in FIG. 18A.

FIG. 19 is a top view of the miter gauge head extrusion.

FIG. 20A is the top view of the miter gauge extrusion shown with a step machined out of the two opposite corners.

FIG. 20B is an enlargement of FIG. 20A.

FIG. 21 is a top view of the T-slot extrusion.

FIG. 22 is a top view of the miter gauge extrusion shown with the steps machined out of the corner and the location of the threaded and through holes showing the T-slot extrusion secured to the miter gauge head with a ¼-20 bolt.

FIG. 23 is a top view of the miter gauge extrusion shown with the extruded fence separated from the miter gauge head shown with the steps machined out of the corner of the miter gauge head and that the distance between the steps is 5.729″.

FIG. 24A is a top view of the miter gauge extrusion shown with the extruded fence secured to the miter gauge head showing the distance between the extruded fence and the miter gauge head is adjusted with a socket head cap screw.

FIG. 24B is an enlargement of FIG. 24A showing the fulcrum point.

FIG. 25A is a top view of the miter gauge extrusion shown with the steps machined out of the corners and that the distance between the steps is 5.729″. It illustrates that when the fence is angled at 1 degree away from the miter gauge head there is a 0.100″ gap between the head and the extrusion which is equivalent to 1 degree.

FIG. 25B is the illustration of a circle with a 5.729″ radius. It illustrates that 1 degree equals a distance of 0.100″ on the circumference of the circle.

FIG. 25C is an enlargement of FIG. 25A.

FIG. 26 is a perspective view of the back of the miter gauge with an extruded track as it is used on a table saw. The dial caliper gauge is used to measure the gap between the miter gauge head and the extruded fence.

FIG. 27A is the top view of the miter gauge extrusion and the T-slot track. The dial caliper is located in the step machined in the corner of the miter gauge head and is zeroed out to 0.100″ which reads “0” on the dial.

FIG. 27B is an enlargement of FIG. 27A.

FIG. 27C is an enlargement of the dial caliper dial shown in FIG. 27A.

FIG. 28A is a top view of the miter gauge extrusion and the T-slot track. The dial caliper is located in the step machined in the corner of the miter gauge head. The T-slot track fence is microadjusted away from the miter gauge extrusion 0.071″ as shown on the dial caliper. The dial caliper is actually measuring 0.171″ which includes the 0.100″ width of the step.

FIG. 28B is an enlargement of FIG. 28A.

FIG. 28C is an enlargement of dial caliper dial shown in FIG. 28A.

FIG. 29 is a perspective view of the miter gauge with an extruded track and flip stop as it is used on a table saw when secured to a sliding sled.

FIG. 30 is an enlargement of FIG. 29 with the sled removed from the table saw.

FIG. 31 is a perspective view of the miter gauge on the sled with extruded track and flip removed.

FIG. 32A is a perspective view of the sliding sled.

FIG. 32B is an enlargement of FIG. 32A showing the sled mini-track.

FIG. 33A is an exploded perspective view of the sled.

FIG. 33B is an enlargement of FIG. 32A showing the sled dado for the mini-track.

FIG. 34A is a perspective cutaway view of the dado in the sled platform showing the fixture bar secured to the bottom of the dado with flat head screws.

FIG. 34B is an enlargement of FIG. 34A showing a flat head screw.

FIG. 35A is an elevation view of the sled showing the fixture bar secured to the bottom of the sled platform with flat head screws.

FIG. 35B is an enlargement of FIG. 35A.

FIG. 36A is a perspective view of the miter gauge showing the through-holes in the bar for securing it to the bottom of the dado in the sled platform with flat head screws.

FIG. 36B is an enlargement of FIG. 36A.

FIG. 37 is an exploded perspective view of the miter gauge and the sled.

FIG. 38A is a perspective cutaway view of the miter gauge secured to the sled showing the fixture bar secured to the bottom of the sled platform with flat head screws and the miter gauge secured to the fixture bar with flat head screws.

FIG. 38B is an enlargement of FIG. 38A, but not showing the sled panel.

FIG. 39A is an exploded perspective view of the miter gauge and the sled fixture bar showing the flat head screws for securing the fixture bar to the bottom of the sled dado and the flat head screws for securing the miter gauge to the fixture bar, but not showing the sled panel.

FIG. 39B is an enlargement of FIG. 39A.

FIG. 40 is an end view of the flip stop assembly and L-shaped fence shown in FIG. 30.

FIG. 41 is an end view of a flip stop with a similar outside shape as the one shown on the flip stop assembly in FIG. 40 except that it is composed of two pieces that are attached together with a ¼-20 bolt.

FIG. 42 is an end view of a flip stop assembly and L-shaped fence shown in FIG. 40 with the curved stop extrusion with the T-slot of the two piece arm and the rear portion removed. With the rear portion removed, there is space to add a zero-degree clearance fence to the track.

FIG. 43 is an exploded end view of the two-piece stop flip arm.

FIG. 44A is an end view of a stop flip arm with two indentation markings on the top and bottom of the curved bottom surface of the flip arm.

FIG. 44B is an enlargement of FIG. 44A showing the two indentations where the extrusion can be broken apart.

FIG. 45 is an exploded end view of the breakable two-piece stop flip arm showing it breaking at the indentations.

FIG. 46A is an end view of the breakable stop flip arm with the back broken off and the rough surface where it was separated rounded off.

FIG. 46B is an exploded end view of FIG. 46A.

FIG. 47 is an end view of a flip stop assembly and L-shaped fence shown in FIG. 40 with the curved stop extrusion with the removable rear portion removed. With the rear portion removed, there is space to add a zero clearance fence.

FIG. 48A is a perspective view of a miter gauge with an extruded T-shaped track fence and flip stop assembly as it is used on a table saw.

FIG. 48B is an exploded view of FIG. 48A.

FIG. 49 is an end view of an extruded T-shaped track fence shown in FIG. 48B.

FIG. 50A is an end view of a flip stop assembly and T-shaped fence shown in FIG. 48B with a zero clearance fence. Inside the opening at the back of the T-shaped fence is a small piece of modified T-track with an interlocking profile that is secured to the T-shaped fence with a standard ¼-20 bolt.

FIG. 50B is an exploded end view of the interlocking minitrack shown in FIG. 50A.

FIG. 51 is a perspective view of the extruded T-shaped track with a zero clearance fence. Inside the opening at the back of the T-shaped fence is a small piece of modified mini-T-track with an interlocking profile which is secured to the T-shaped fence with a standard ¼-20 bolt (not shown). The interlocking minitrack is shown extended out of the extruded T-shaped track.

FIG. 52 is an end view of an extruded T-shaped track fence with the interlocking minitrack secured in place with a standard ¼-20 bolt.

FIG. 53A is an end view of the interlocking minitrack with a standard ¼-20 bolt located in the T-slot.

FIG. 53B is an exploded view of FIG. 53A showing the interlocking female profile.

FIG. 54A is an end view of an extruded T-shaped track fence with the head of a standard ¼-20 bolt captured between the interlocking male profiles of the interlocking mechanism.

FIG. 54B is an exploded view of FIG. 54A showing the interlocking male profile.

FIG. 55A is a perspective view of the miter gauge with an extruded T-shaped track fence as it is used on a table saw when secured to a sliding sled. An interlocking minitrack is used to secure a short piece T-shaped track fence at the far end of the fence allowing the flip stop assembly to be accurately positioned farther away from the blade than is possible with the standard fence.

FIG. 55B is an exploded view of FIG. 55A showing a cutaway view of the interlocking minitrack.

FIG. 55C is an exploded view of FIG. 55B showing an enlarged cutaway view of the interlocking minitrack.

### DETAILED DESCRIPTION OF THE PREFERRED EMBODIMENTS

FIG. 1 illustrates a miter gauge 10 of the invention shown in a miter slot on a table saw. This is an improvement of the miter gauge in U.S. Pat. No. 5,337,641 and U.S. Pat. No. 5,768,966, the entire disclosures of which are hereby incorporated by reference for their teachings of how to make and use jigs and fixtures. The drawing is a perspective view of a miter gauge 10 with the miter bar 14 located in the table saw miter slot 22.

U.S. Pat. No. 5,768,966 discloses improved jigs and fixtures for aligning, guiding and or holding a workpiece as it is worked, for example as it is cut, drilled or routed. While the miter gauge disclosed in U.S. Pat. No. 5,768,966 represent a significant advance in the art, room still exists for improvements, particularly in the following respects:

The machined numerals of the '966 patent, which are expensive to manufacture, are replaced with a printed scale with a yellow background 50 for easy visibility with black lines and numbers that are printed 0.007″ in width for very fine adjustment.

The miter head 29 rotates around the threaded stud 70 and is adjustable to different angles and is secured at the desired angle position by the tightening the miter gauge handle 16. Location holes 13 at the commonly used angles of 0, 10, 22.5, 30 and 45 accept the miter gauge location pin 34 for easily setting the desired angle. The width of the miter gauge head 29 has been reduced in width from the '966 patent allowing it to be used on machines such as a band saw.

In this invention the modified Vernier scale 52 is fitted to an injection molded plastic (33% glass filled nylon) holder 38 which is secured to the miter gauge bar 14 with button head cap screws 72. The injection molded plastic (33% glass filled nylon) holder 38 can be adjusted on the bar so it can be zeroed out to the degree scale on the miter gauge. The modified double Vernier scale and holder are curved to match the curve of the miter gauge head 29. Two button head ¼-20 cap screws 72 secure the Vernier scale to the bar 14.

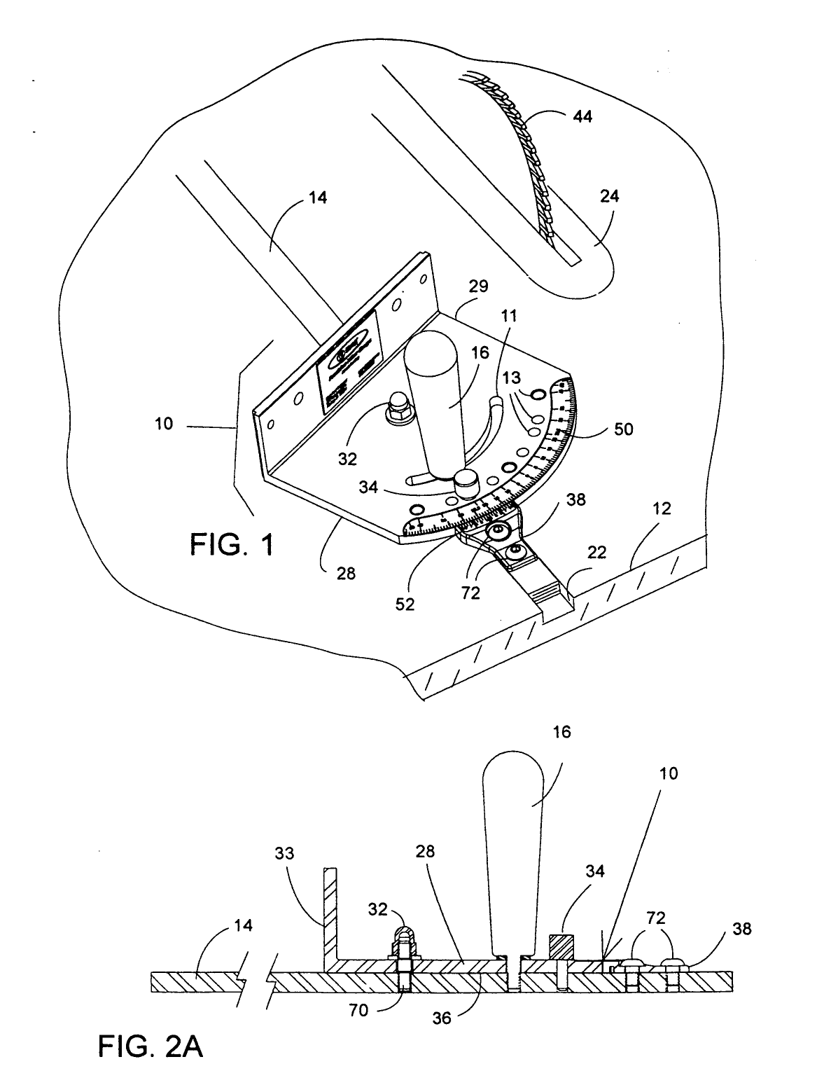

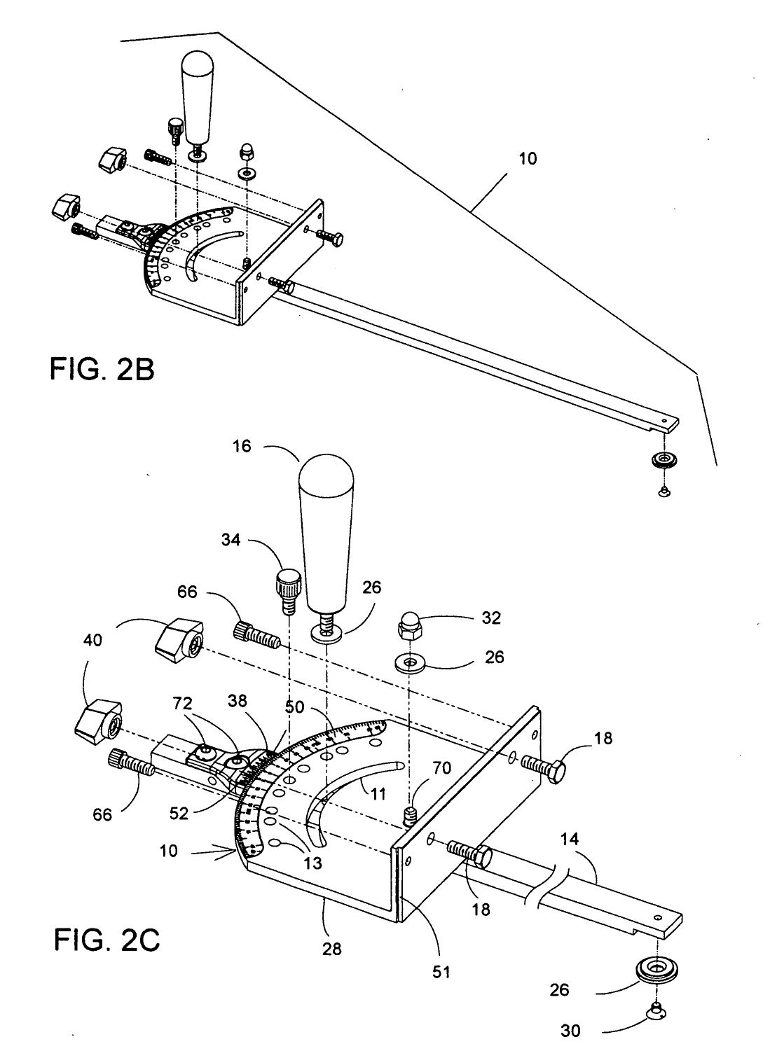

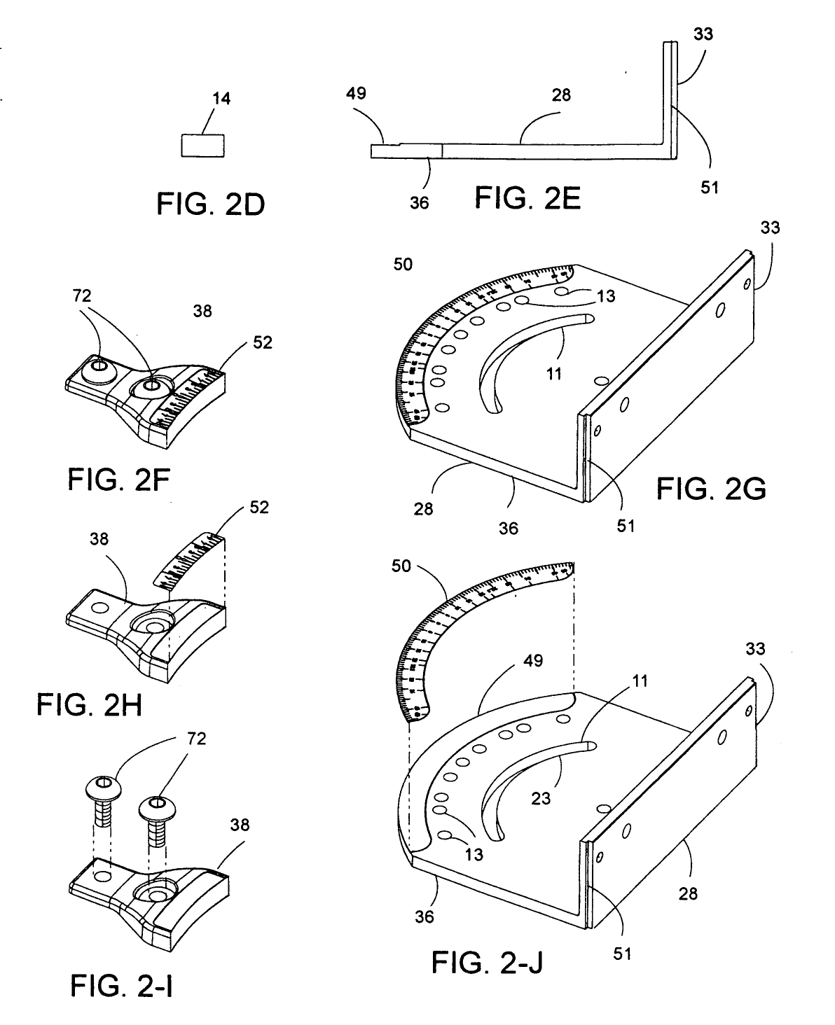

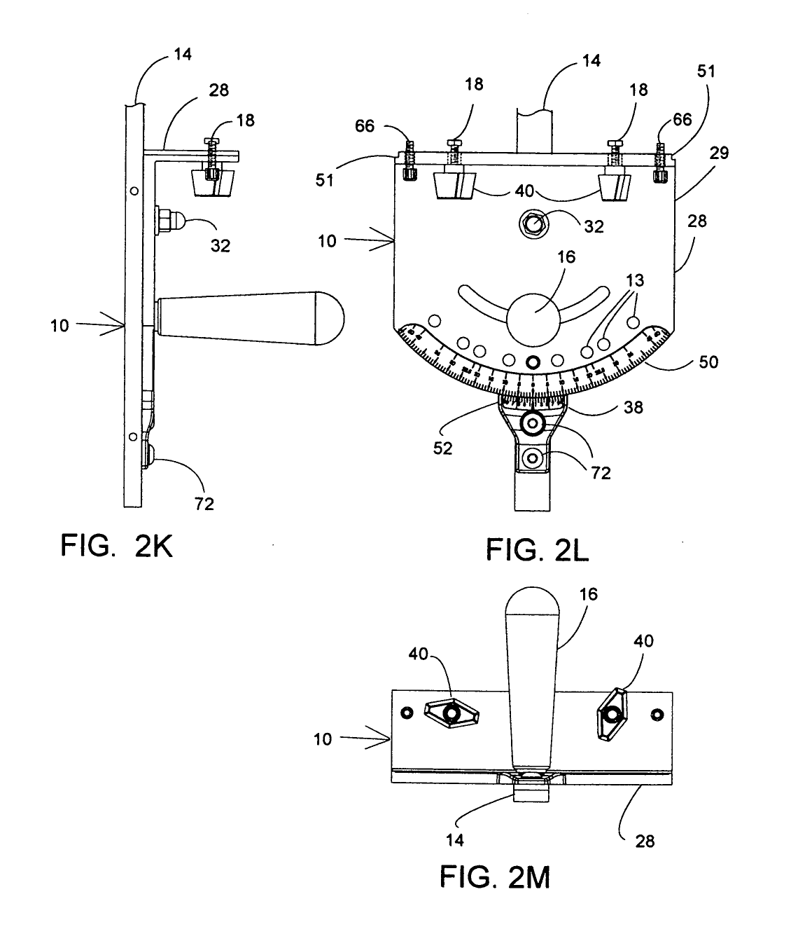

FIG. 2A is a side view of the miter gauge 10 showing the L-shaped extrusion 28 secured to the bar 14 with a front rotation point provided by a threaded stud 70 and a lock nut 32 and the back of the miter gauge extrusion 28 is secured to the bar 14 with miter gauge handle 16 that is loosened to adjust the angle position and tightened to secure it.

FIG. 2C is an exploded view of the miter head showing the miter handle 16 is threaded to the bar 14 and the head 29 rotates on the threaded stud 70. The miter gauge handle 16 is surrounded by a machined arc slot 11.

FIGS. 2D and 2E are end views of the miter bar 14 of the L-shaped extrusion 28 of the miter gauge head 29, which is the same extrusion used in the miter gauge of the '966 patent.

FIG. 2F is a perspective view of the Vernier scale holder 38 with the Vernier scale 52 in place showing that the it is secured to the bar with two socket head cap screws 72.

FIG. 2G is a perspective view of the of the extrusion 28 of the miter gauge head 29 with the scale 52 located in machined groove 49.

FIGS. 2H and 2J are exploded perspective views of the Vernier scale holder 38 and the Vernier scale 52 and the extrusion 28 of the miter gauge head with the miter head angle scale 50. The machined groove 49 is machined on a CNC milling machine with a 0.500″ cutter. The printed angle scale 50 and the Vernier scale 52 are bright yellow for easy visibility with black numbers and black lines that are printed 0.007″ in width for very fine adjustment. Red arrows and red diamonds accentuate the most commonly used settings. The scale 50 and the Vernier scale 52 are 0.020″ aluminum with a self adhesive back that is die cut for ISO 9002 accuracy. The die cut shape exactly fits the machined groove 49 of the extrusion 28. The scale 50 and the Vernier scale 52 are printed as matched sets so that any error is consistent. This design greatly improves the readability of the scale and decreases the cost of the machined numerals of the '966 patent miter gauge angle scale.

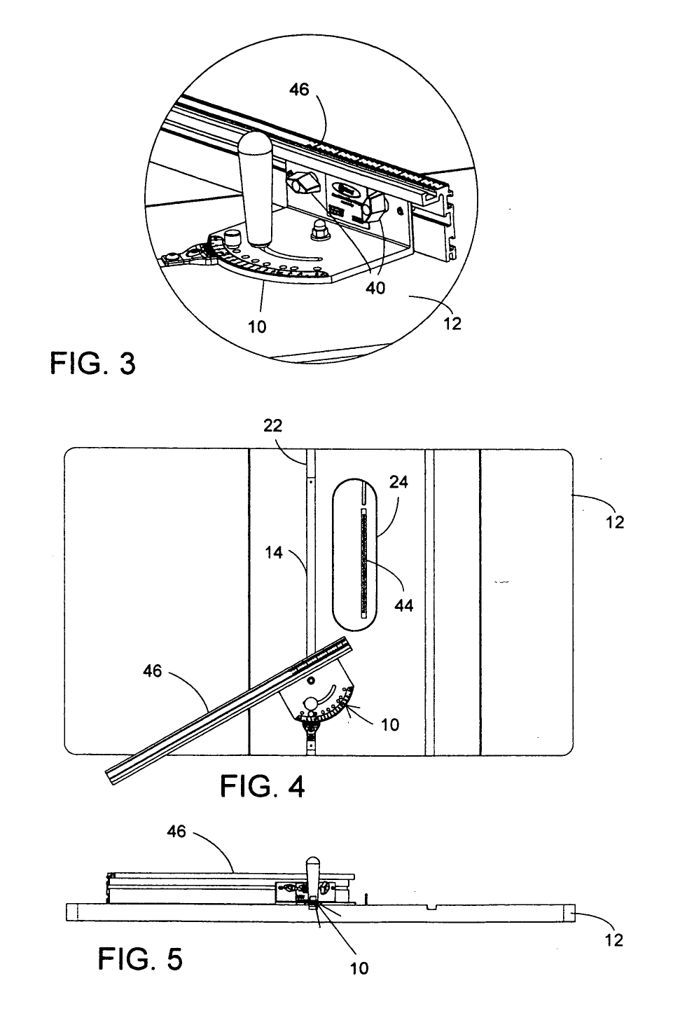

Referring to FIG. 3, which is a perspective view of the miter gauge 10 set at a 30 degree angle and positioned in the miter slot as it is used on a table saw with an extruded L-shaped fence 46 of U.S. patent application Ser. No. 10/944,035, the disclosure of which is hereby incorporated by reference for its teaching of the fence 46. The L-shaped extrusion of U.S. Pat. No. 5,768,966 also bolts to the miter gauge without any modification. FIGS. 4 and 5 show the miter gauge 10 with the fence extrusion 46 from the top and back elevation.

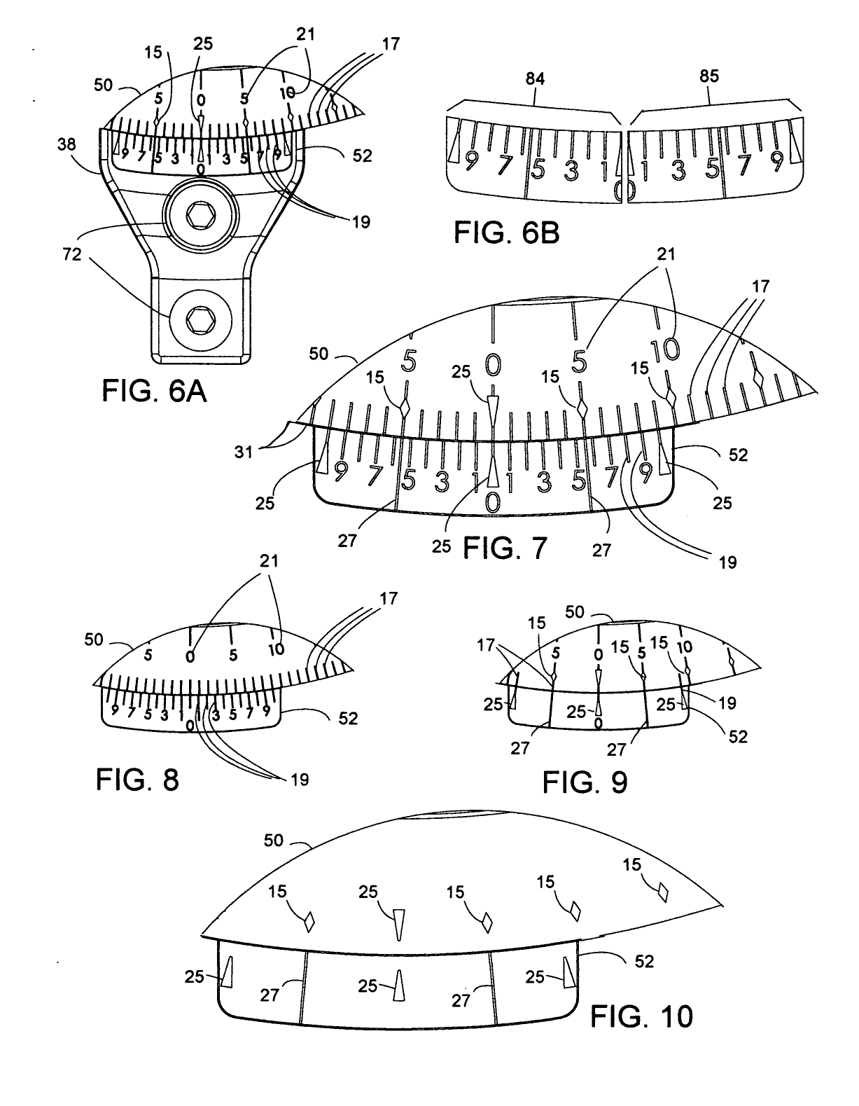

Referring to FIG. 6A, which is a top view of the miter gauge 10 set at 90 degrees between the miter head 29 and the bar 14, which registers as “0” on the degree scale 50 and “0” on the Vernier scale 52. This view shows a cut away view of the scale 50 aligned with the Vernier scale 52 located in the Vernier scale holder 38. In this application the modified Vernier scale 52 is fitted to an injection molded plastic (33% glass filled nylon) holder 38 that can be adjusted on the bar 14 with two button head cap screws 72 so it can be zeroed out to the degree scale 52 on the miter gauge 10. The modified double Vernier scale 52 and holder 38 are curved to match profile of the miter gauge head 29.

The printed degree scale 50 and the Vernier scale 52 have bright yellow backgrounds for easy visibility. The Vernier scale numbers 19 and the degree scale numbers 17 are black lines that are printed 0.007″ in width for very fine adjustment. Scale numerals 21 in multiples of 5 degrees are printed on the miter gauge scale 50.

Referring to FIG. 6B which is an enlargement of the double Vernier scale in 6A, it shows that there are actually two Vernier scales placed side by side. The left Vernier Scale 84 is used when the miter gauge head 29 is rotated to the left thus using the left half of the miter gauge scale 50. The right Vernier Scale 85 is used when the miter gauge head 29 is rotated to the right thus using the right half of the miter gauge scale 50.

FIG. 7 is an enlargement of FIG. 6 showing the Vernier scale 52 aligned with the miter gauge 10 degree scale 50. The “0” on both scales is accentuated with a color coded red arrow 25 which makes it easy to locate the zero location on either scale.

The bar line and pointer of the '966 patent are replaced with this full size modified double Vernier scale 52. The Vernier scale was developed by the French mathematician Vernier for dividing measurements into decimal fractions. The Vernier scale lines and numbers are printed 0.007″ in width for very fine adjustment. The modified double Vernier scale allows the miter gauge to be very accurately adjusted to 1/10 of a degree in a matter of seconds.

The modified double Vernier scale 52 is actually two mirror image Vernier scales, one scale for each half of the miter gauge head as shown in FIG. 6A, which shows the left Vernier Scale 84 for the left side of the miter gauge scale and the right Vernier Scale 85 for the right side of the miter gauge scale. Ten equally spaced lines 19 on each Vernier scale 52 are aligned within the space of nine degree lines 17 on each side of zero of the miter gauge scale 50. To align the Vernier scale 52, the “0” line on the Vernier scale is aligned with the “0” line on the degree scale 50 of the miter gauge head 29. The distance between the miter gauge head 29 arid the Vernier scale holder 38 is 0.005” and that distance is calibrated with a 0.005″ shim 31 during assembly of the miter gauge. The 0.005″ distance between the miter gauge head 29 and the Vernier scale holder 38 is designed to provide some clearance so that when the miter gauge 29 is rotated it doesn't rub against the Vernier scale holder 38. The Vernier scale 52 and the miter gauge scale 50 are printed as a matched set so that any error in the printing process is the same on both scales. The 0.005″ space between the Vernier scale 52 and the miter gauge scale 50 distance is calibrated with a 0.005″ shim 31 and that space is taken into consideration when the scales are printed a s a set and then very accurately die cut.

The Vernier scale holder 38 is laterally adjustable to align the “0” lines on each scale.

In this invention the readability of the scales is improved by a new indicia coding design in which significant features are designated with indicia such as arrows, diamonds lines of a different color or lines of a different length. Red arrows 25, diamonds 15, and red lines 27, which are also longer than the other lines on the Vernier scale, accentuate the most commonly used settings. Red arrows are added to the “0” lines of the degree scale 50 and the “0” of the Vernier scale 52.

Red arrows 25 are also placed on the “10” lines on the Vernier scales which correspond to full degrees for easy reference when aligning a full degree measurement.

Red diamonds are positioned on the degree scale 50 at numeral lines that are multiples of 5 degrees such as 5, 10, 15, 20 etc. This helps for a quick reference.

The red arrow 25 on the “0” lines of the Vernier scale 52 makes it easy to see which lines are being used to set the desired angle.

When using the Vernier scale, the desired angle on the miter guide is aligned with the zero line of the Vernier scale. If the adjustment is for a whole degree the “0” line on the Vernier scale is aligned with the desired angle line on the miter gauge scale. However, there may be some error when lining up the two lines. The problem of accurately aligning two lines with each other is one of the problems solved by this modified double Vernier scale 52.

The modified double Vernier scale makes it easy to align full degree lines by expanding the reference points over the entire double Vernier scale 52. When the miter gauge is set at 90 degrees the 0 line on the miter bar angle scale, which is the Vernier scale 52, lines up with the 0 line on the miter head angle scale 50. At the 90 degree setting, the two Vernier scale 10 lines on each side of the Vernier scale 52 are aligned with the two 9 degree lines on the miter head angle scale 50. By lining up the outside lines, which are the number 10 lines, on the Vernier scale 52 with the full degree lines on the miter gauge degree scale it is easy to accurately set the miter gauge for full degrees. Thus, by expanding the reference points from the 10 line on one side to the 10 line on the other side of the Vernier scale it is easier to adjust the miter gauge accurately for full degrees.

Another feature that helps to set angles that are full degrees is the addition of two lines 27 on the Vernier scale that correspond with the 5 degree miter head scale 50 angles when the miter gauge is set at 90 degrees as shown in FIG. 7. The lines 27 are longer than the other lines on the Vernier scale and are preferable red so as to be distinguishable. The lines 27 correspond to full degree settings and are another reference for accurately setting full degree angles. Because the lines are the only red lines and are longer, they stand out as a quick reference. Thus, for whole angle measurements, there are five sets of lines that are aligned: the three arrow positions 25 on the Vernier scale and the longer lines 27 on the Vernier scale all line up with lines on the miter head scale to improve the resolution accuracy of setting angles.

FIG. 8 is similar to FIG. 7 but the color coded arrows, diamonds and full degree alignment lines have been removed. By removing these reference symbols the scale is much harder to read.

FIG. 9 is similar to FIG. 7 but the full degree lines other than the 5 degree lines have been removed and the lines on the Vernier scale other than the 0 and 10 degree lines have been removed.

FIG. 10 is similar to FIG. 7 with only the color coded arrows, diamonds and full degree alignment lines. These symbols are additions to the scale design of this invention and greatly improve the ease of reading the scale.

The Vernier scale on a dial caliper or other machine tool has traditionally been used to measure fractions of a degree such as a 1/10^{th} of a degree or 1/25th of a degree. Another feature of the modified double Vernier scale 52 of this invention is used to measure 1/10th of a degree increments. The 0 line and the 10 line on the Vernier are lined up with a line of the miter head scale 17 for a full degree setting. The 1 to 9 numbers on the Vernier scale 19 each represent 1/10th of one degree. A 1/10th degree measurement is achieved by lining up one of the 1 to 9 Vernier number lines 19 with a full degree line 17 on the miter scale.

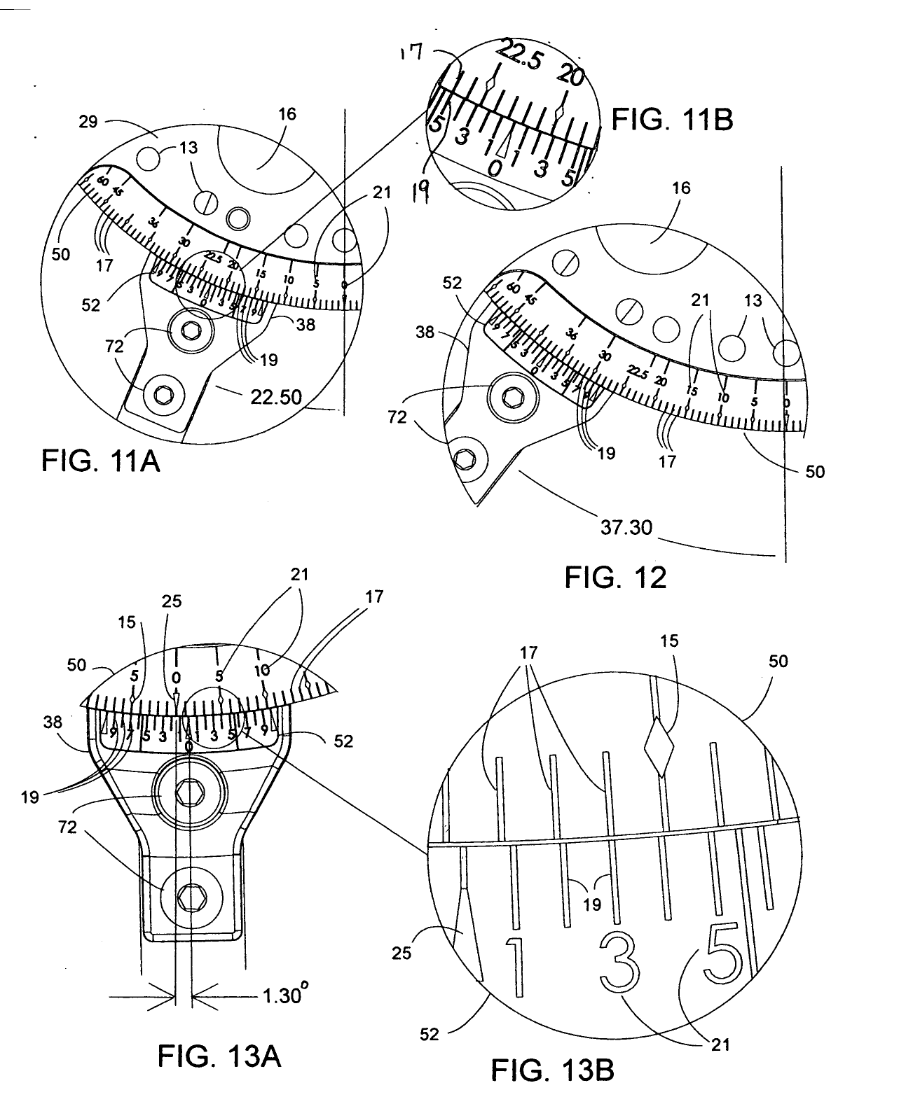

FIG. 11 is an example of the miter gauge 10 with the miter gauge head 29 adjusted to 22.5 degrees which is the angle used for cutting a frame with 8 sides. The miter gauge head is rotated so that the line for the “0” on the Vernier scale 52 is located approximately half way between the 20 and 25 degree settings. Because the left side of the miter gauge head is used for setting the angle the Vernier scale on the left side is used to set the tenth of a degree setting.

Referring to FIG. 11B, to achieve the 22.5 degree measurement, the number 5 line on the left side Vernier scale 52 is aligned with a line 17 on the degree scale 52.

FIG. 12 is an example of setting the miter gauge for 37.30 degrees. The “0” line of the Vernier scale 52 is aligned about one third of the way past the 37 degree line 17. To accurately measure the additional 3/10ths of a degree, the 3 line 19 on the Vernier scale 52 is aligned with the nearest full degree line 17 on the miter scale 50. This design allows a 1/10th degree measurement to be achieved easily simply by lining up two lines. No manipulation of any additional mechanism is required.

FIG. 13A is an example of setting the miter gauge for 1.30 degrees. FIG. 13B is an enlargement of FIG. 13A showing that the “0” line of the Vernier scale 52 which is designated by an arrow 25 is located about a third of the way past the one degree line 17. The 3 line 19 on the Vernier scale 52, which represents 3/10th of a degree, is aligned with a full degree line 17 on the degree scale 50.

Some woodworking tasks, such as cutting odd numbered frames requires setting the miter gauge to an angle adjustable to 1/100^{th} of a degree. For example, cutting a frame with seven sides requires setting the miter gauge accurately to 25.71 degrees. Cutting compound angles also requires unusual angles adjustable to 1/100^{th} of a degree. The miter gauge 10 of this invention is the first to have 1/100^{th} of a degree adjustability. The Miter Gauge 10 of this invention was designed to quickly be adjusted to 1/100^{th} of a degree using ordinary shop tools such as a feeler gauge 45 or dial caliper 39.

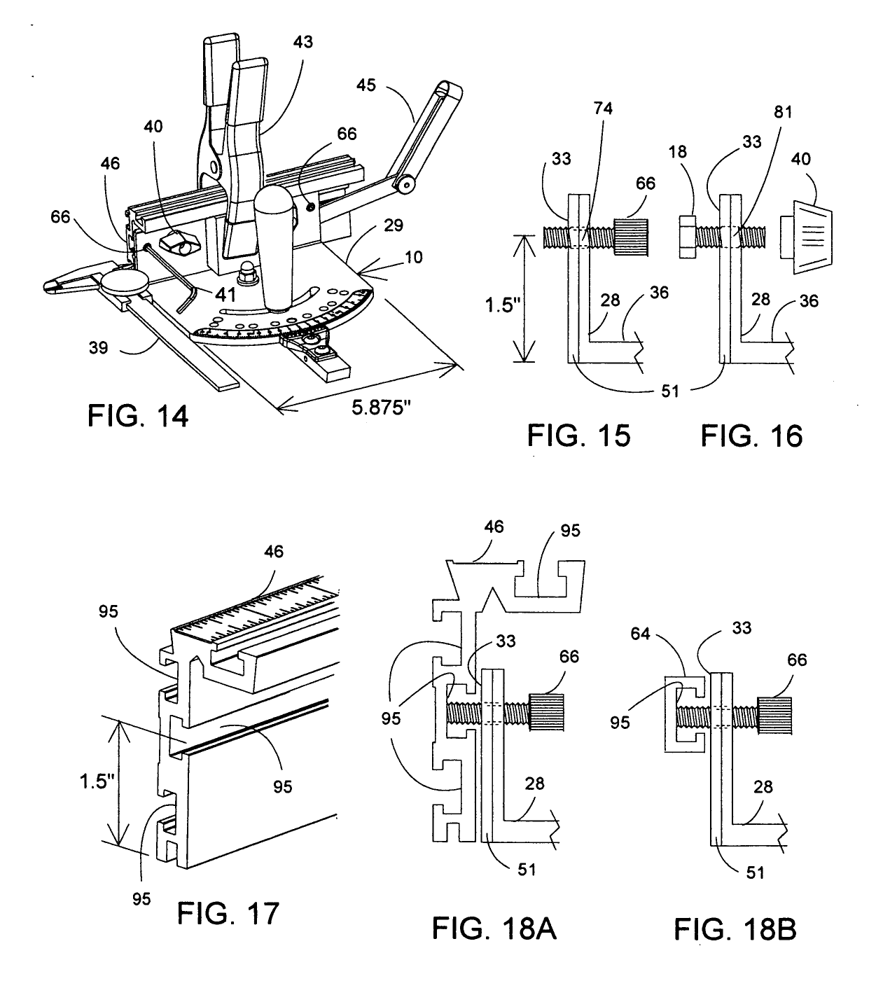

FIG. 14 illustrates that the fine adjustment of the cut angle is made by microadjusting the distance between the short leg of the miter gauge head 33 and the fence extrusion 46 and that the feeler gauge 45 or dial caliper 39 are used to accurately measure that distance. The socket head cap screw 66 is used to microadjust the measurement. Using an Allen wrench 41 to adjust the socket head cap screw 66 is useful because it helps to approximate the amount the ¼-20 thread is rotated. The machined head of the miter gauge 29 is 5.875″ wide with parallel sides.

As shown in FIG. 14, the miter gauge head is an L-shaped aluminum extrusion that is machined to a 5.875″ width with parallel sides. This width decreases the amount of material used compared to the miter gauge of U.S. Pat. No. 5,768,966, and the amount of machining. It also allows the miter gauge to be used on a bandsaw and does not contact the standard tablesaw guard.

This shape, with parallel sides, simplifies the CNC machining process without the need for expensive fixturing. The face 33 of the miter head 10, which is the short leg of the L-shaped extrusion 28, is machined at a 90 degree angle on a CNC milling machine. This guarantees that the face 33 of the miter gauge head 10 is square to the saw table. Machined holes are located in a row for easily cutting frames with 4,6,8, and 18 sides. Other frame angles are accurately adjusted by use of the Vernier scale or the 1/100th of a degree adjustment mechanism.

FIGS. 15 and 16 are end views of the L-shaped extrusion 28 from which the miter gauge head 29 is machined. The short leg of the miter head 33 which is the front face of the miter gauge 10 is accurately machined exactly 90 degrees to the long leg 36 of the L-shaped extrusion 28.

As shown in FIG. 15, the socket head cap screws 66 are located 1.5″ from the outside corner of the L-shaped extrusion 28. The socket head cap screws 66 are screwed into a threaded hole 74 in the miter head 29. As shown in FIG. 16, the same 1.5″ distance from the outside corner, which corresponds to the surface of the machine work table, is the location of a through hole 81 in which a ¼-20 bolt 18 is received and is secured with a knob 10.

The same 1.5″ distance from the table top to the middle of the through hole 81 in which a ¼-20 bolt 18 is received corresponds to the T-slot 95 on the fence extrusion 46 as shown in FIG. 17. FIG. 18A is a side view of FIG. 14 showing how the socket head cap screw 66 and also the ¼-20 bolt 18, which is not shown in the drawing, is aligned with the T-slot 95 on the fence extrusion 46. The heads of the bolts 18 are received in the T-slot 95 and the screws 66 bottom against the bottom of the T-slot 95.

FIG. 18B is a side view of FIG. 18A showing the fence extrusion 46 replaced with a piece of minitrack 64 which is a ⅜″ by ¾″ extrusion with a T-slot 95 located in the middle of it. The minitrack 64 is useful when making jigs or fixtures which attach to the miter gauge. The minitrack 64 can be located in a dado in a jig or fixture board.

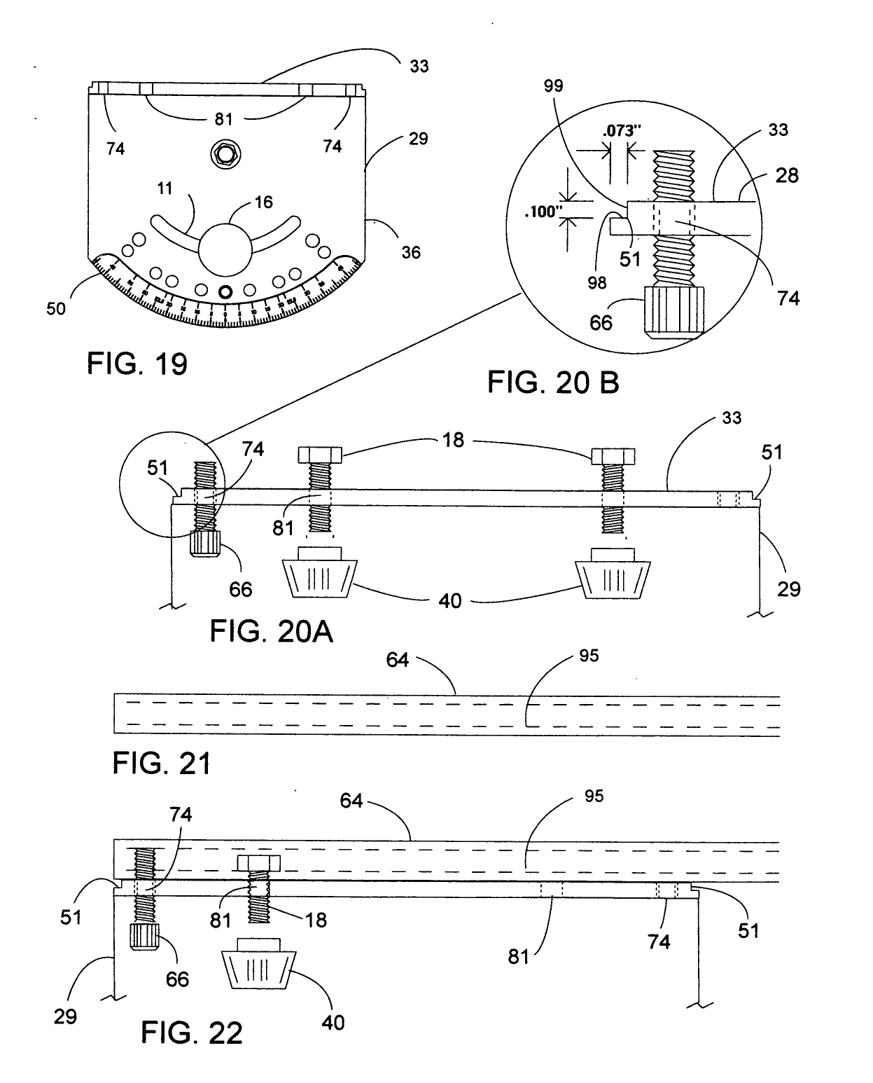

FIG. 19 is the top view of the miter gauge head 29.

FIG. 20A is an enlarged top view of the front of the miter gauge head 29 showing that two holes in the short leg of the miter head 29 are through holes 81 which accept the two ¼-20 bolts 18 for securing the fence extrusion 46 to the short leg 33 of the miter gauge head 29. A set of threaded holes 74 are located near the outside edge of the short leg 33 miter gauge head 29 in which the socket head cap screw 66 is located. Also shown is a step 51 machined out of the two opposite corners of the front face 33 of the miter head 29. The step 51 defines a ledge 98 that is spaced 0.100 inches back from the front face 33 of the miter head 29.

FIG. 20B is an enlargement of FIG. 20A showing that the step 51 is machined 0.100″ deep to define ledge 98 and 0.073 wide, from the end surface to side surface 99. By machining the step 51 in each corner the machined face 33 of the miter gauge head 33 is reduced to 5.729″ wide.

FIG. 21 is the top view of the minitrack T-slot extrusion 64 with the T-slot 95. FIG. 22 is the top view of the minitrack T-slot extrusion 64 with the T-slot 95 secured to the short leg of the miter head 33 with a ¼-20 bolt 18, against front face 33.

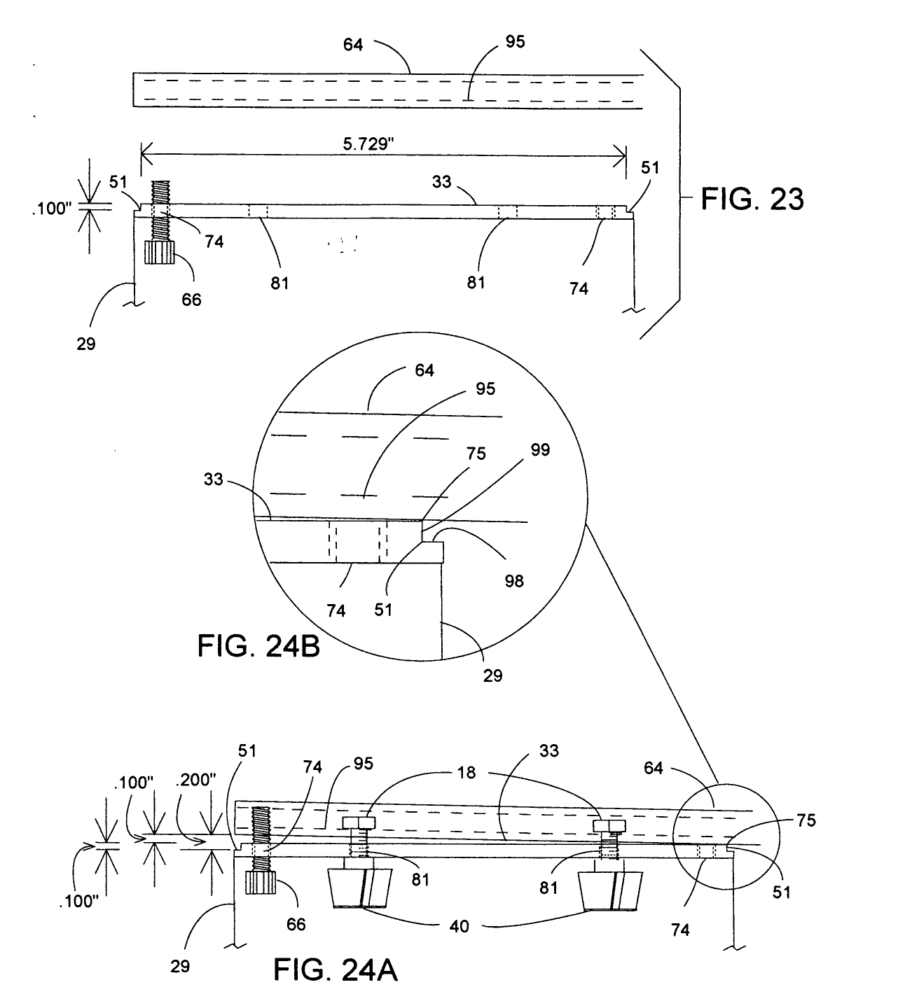

FIG. 23 is the top view of the minitrack T-slot extrusion 64 with the T-slot 95 and the front face 33 of the miter head 29 showing that the distance between the two steps 51 is 5.729″ wide. The distance, 5.729″, is significant as a trigonometric calculation for the 1/100^{th} of a degree adjustability.

FIG. 24A shows the extrusion 53 being advanced away from the front surface 33 of the miter gauge 29 by rotating the socket head cap screw 66 against the bottom wall of the T-slot 95. On the opposite side of the front surface 33 of the miter gauge 29 from the socket head cap screw 66 is the fulcrum point 75, which is the corner where the front surface 33 of the miter gauge head 29 meets with the side surface 99 of the step 51. The fulcrum point 75 is where the fence extrusion 46 or the minitrack 64 contacts the front surface 33 of the miter gauge head 29.

FIG. 24B is an enlarged view showing the fulcrum point 75 where the extrusion 64 contacts the front surface 33 of the miter gauge head 29.

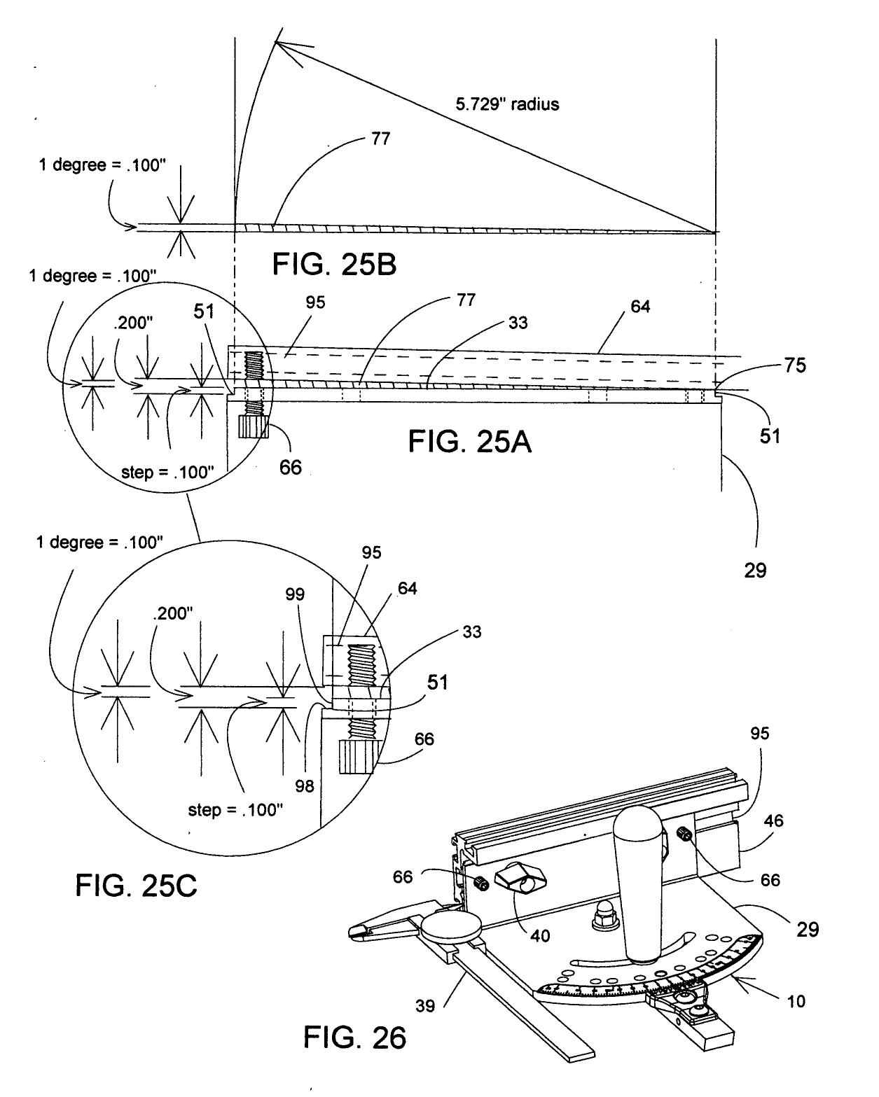

FIG. 25A illustrates that the front surface 33 of the miter gauge 29 and the angled fence extrusion 64 are an example of two planes intersecting at one point. When two planes intersect at one point the angle created between the two planes can be measured in a number of ways including the use of trigonometry. In this case, the fence extrusion is the hypotenuse of the triangle.

When two planes intersect at a 1 degree angle the distance between the two planes is 0.100″ at a distance of 5.729 inches from where the planes intersect which corresponds to the fulcrum point 75. For this reason the width of the miter head front face 33 between the steps 51 is 5.729 inches.

FIG. 25B illustrates a circle with a radius of 5.729 inches and that on the circumference of the circle one degree would measure 0.100″. The one degree is represented by a wedge 77 that is has two planes that touch on one end and are spaced away from each other 0.100″ at a distance of 5.729 inches from the point at which the planes touch.

FIG. 25C is an enlargement of FIG. 25A that illustrates that each step, which is machined 0.100″ of an inch into the corner of the extrusion when added to the 0.100″ of the 1 degree measurement would measure a total of 0.200″.

FIG. 26 illustrates the position of the dial caliper 39 used to measure the distance between the front surface 98 of the step 51 and the fence extrusion 46.

The socket head cap screw 66 is used to microadjust one side of the fence extrusion 45 away from the machined short leg 33 of the miter gauge head 29. As the fence extrusion is microadjusted the distance between the front face 33 of the miter gauge head 29 and the fence extrusion can be measured using a feeler gauge 45 or a dial caliper 39. Both the feeler gauge and the caliper measure in thousands of an inch.

To accurately measure the small changes in the angle of the fence extrusion the angle adjustment is represented in thousandths of an inch so it can be measured with the feeler gauge 45 or a dial caliper 39. In this situation, the ideal scenario is to have the thousandthth of an inch of measurement, which is easily measured with a dial caliper 39, represent 1/100^{th} of a degree of fence adjustment for an easy reference. Thus no math, formula, or calculation is needed to figure out the correct measurement required for a specific angle. The miter gauge 10 of this invention is designed so that every 0.001″ measured on the dial caliper 39 or feeler gauge 45 is equal to 1/100^{th} of a degree.

To easily achieve 1/100^{th} of a degree adjustability, a step 51 is machined on each outside corner of the face of the miter head extrusion.

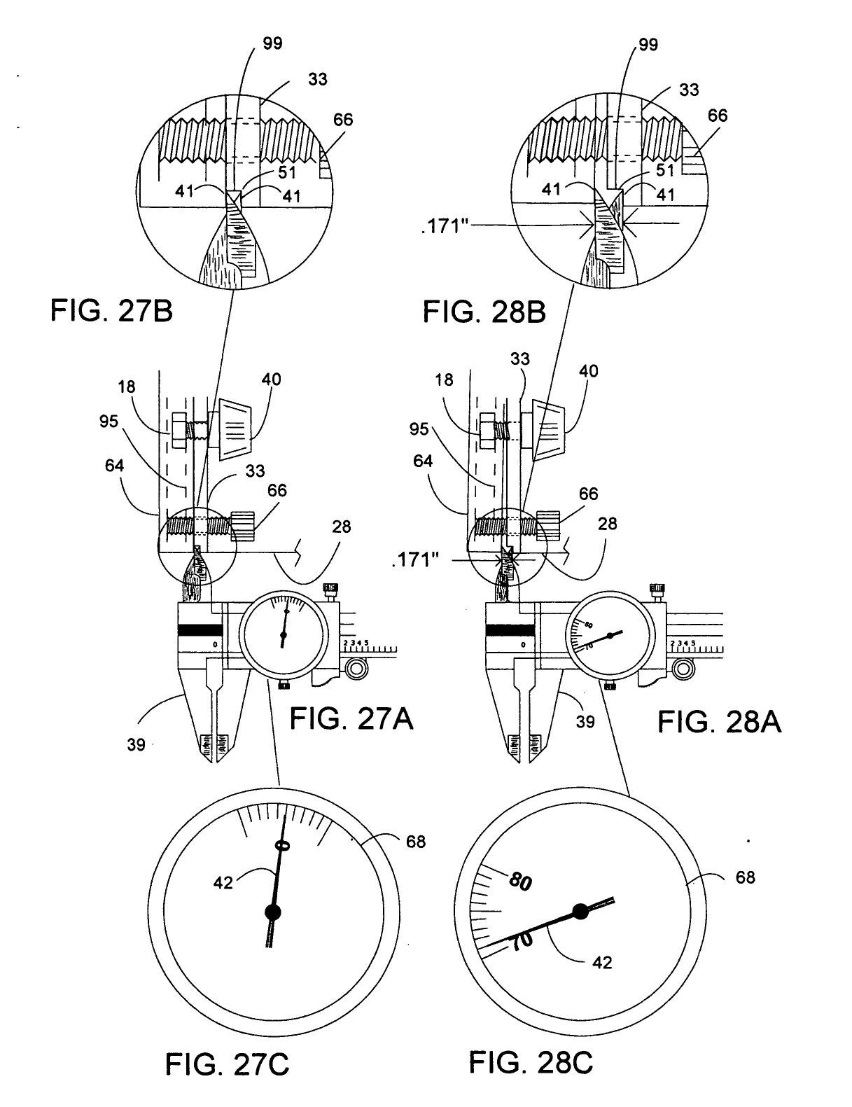

FIG. 27A illustrates that each step 51, which is machined 0.100 of an inch into the corner of the miter face extrusion 33, has two functions. One purpose of the step 51 is that it provides a depth stop for the tip of the caliper 41 or the feeler gauge 45 so that the measurement is always 5.729″ from the opposite corner of the face 33 of the miter gauge head 29, which is the fulcrum point 75. This is important because if it is any other number than 5.729″, an important trigonometric calculation is off.

The second reason for the step 51 is that it makes it easier to use a dial caliper 39. When measuring a narrow width, the points of the caliper 41 can not be advanced very far before the outside curved arm of the caliper contacts the wall of the spacing being measured. The step 51 depth of 0.100″ allows the points of a caliper 41 to reach in 0.073″ to contact the inside wall 99 of the step 51 which is where the measurement should be taken from. The advantage of the 0.100″ step measurement is that it allows a dial caliper 39 to be used without any additional math or calibration. One rotation of the needle 42 of the dial caliper 39, which is 0.100″, returns the needle 42 back to the “0” position as shown in FIG. 27A on the dial 68 of the dial caliper 39.

As shown in FIG. 27A the first rotation of the dial caliper 39, which is 0.100″, is used for the space of the step 51. FIG. 27B is an enlargement of FIG. 27A showing the tips 41 of the dial caliper 39 in the step 51 on the corner of the face of the miter gauge 33. FIG. 27C is an enlargement of the dial 68 of the dial caliper 39 showing that when measuring the width of the step 51, which is 0.100″, the needle 42 makes one rotation and returns back to the “0” position.

The first step in measuring to one hundredth of a degree is to secure the fence extrusion 46 or the minitrack 64 to the front face 33 of the miter gauge head 29. The dial caliper 39 should be rotated to measure the step 51 which should be one rotation of the dial caliper 39 returning the needle 42 back to the “0” position. There may be some discrepancy so that the needle doesn't return to the “0” position. In that case the adjustment on the dial 68 should be used so that it is “zeroed out” so that it reads with the needle at the “0” position.

When using a caliper, it is best if the end of the fence extrusion 46 or minitrack 64 is aligned flush with the edge of the miter gauge head 29. When using a feeler gauge it is best if the fence extrusion extends past the miter gauge head so the fence can help support and locate the feeler gauge blades.

FIG. 28A illustrates the adjustment of the miter gauge to cut a 25.71 degree angle for making a frame with 7 equal sides. First the miter gauge head 29 is adjusted to read 25 degrees. The 0.71 degree adjustment is made by microadjusting the minitrack 64 0.071″ away from the front surface 33 of the miter gauge head 29. FIG. 28A illustrates that the tips 41 of the caliper 39 are measuring the step 51, which is 0.100″, and the distance between the face of the extrusion 33 and the distance between the minitrack extrusion as 0.171″.

FIG. 28B is an enlargement of FIG. 28A showing that the tips 41 of the dial caliper 39 are measuring at the width of the step 51 and are measuring the distance between the minitrack extrusion and the surface 98 as 0.171″. FIG. 28C is an enlargement of FIG. 28A showing the dial 68 of the dial caliper 39 reading 0.071″, which is the distance between the face of the miter gauge 33 and the extrusion 64.

The first rotation of the dial caliper dial reads the space of the step 51 and the second rotation of the dial caliper is used to measure how far the set screw 66 advances the fence extrusion 64 or 46 in relationship to the machined head 33 which in this case is 0.071″. The 0.001″ measurement of a feeler gauge 54 or dial caliper 39 between the face 33 of the miter head 29 and fence extrusion 46 or minitrack 64 corresponds to 1/100 of a degree of angle between the miter head and the fence extrusion.

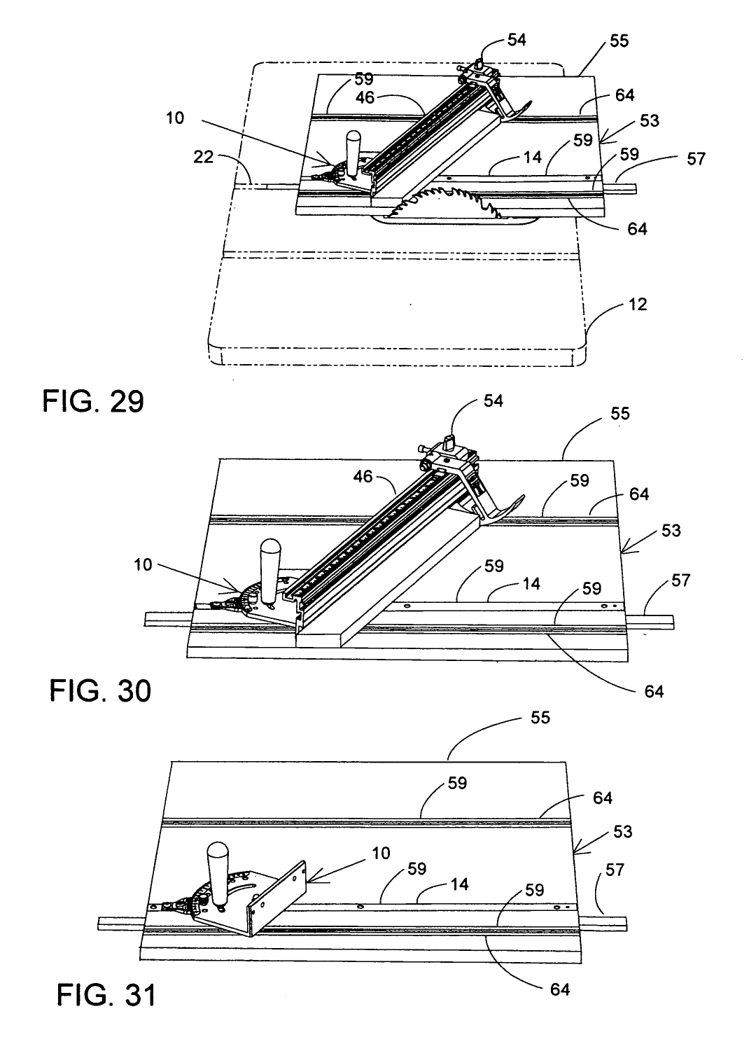

Referring to FIGS. 29, 30 and 31, it has been a common practice when working with a table saw for the user to make a sliding sled, which is a sliding platform with a runner that fits into the miter slot. The sled has the advantage of supporting the board from below as it is advanced into the table saw blade during the saw cut. The sliding sled has the advantage over the miter gauge of providing better support for large boards which can bind even with the miter gauge reversed in the miter slot. The sled is also advantageous for cutting small pieces because these delicate pieces can be clamped to the sled platform and safely moved into the blade.

The sled platform also provides a zero-clearance support under the workpiece preventing tear out and chipping on the bottom of the board. Commercially made sleds are available from Delta, Dubby, Incra, Jointech and Woodhaven.

FIG. 29 is a perspective view of the miter gauge 10 of the invention with an extruded fence track 46 and the flip stop assembly 54 that are improvements of the stop assembly and track of the '966 patent. U.S. patent application Ser. No. 10/944,035 has been filed disclosing this improved track and stop assembly. The miter gauge 10 is located on top of a sliding sled 53 with a platform 55 that is secured to a fixture bar 57. The miter gauge bar 14 is positioned in a dado 59 located above the fixture bar 57. The sled 53 is positioned on the left side of a table saw 12 with the fixture bar 57 running in the left miter slot of the table saw. A piece of minitrack 64 is located in a dado 59 near the center of the sled platform 55 and another piece of minitrack is located in a dado near the blade.

FIG. 30 is an enlargement of FIG. 29 with the sled 55 removed from the table saw and FIG. 31 is a perspective view of the miter gauge 10 on the sled with extruded track 46 and flip stop assembly 54 removed.

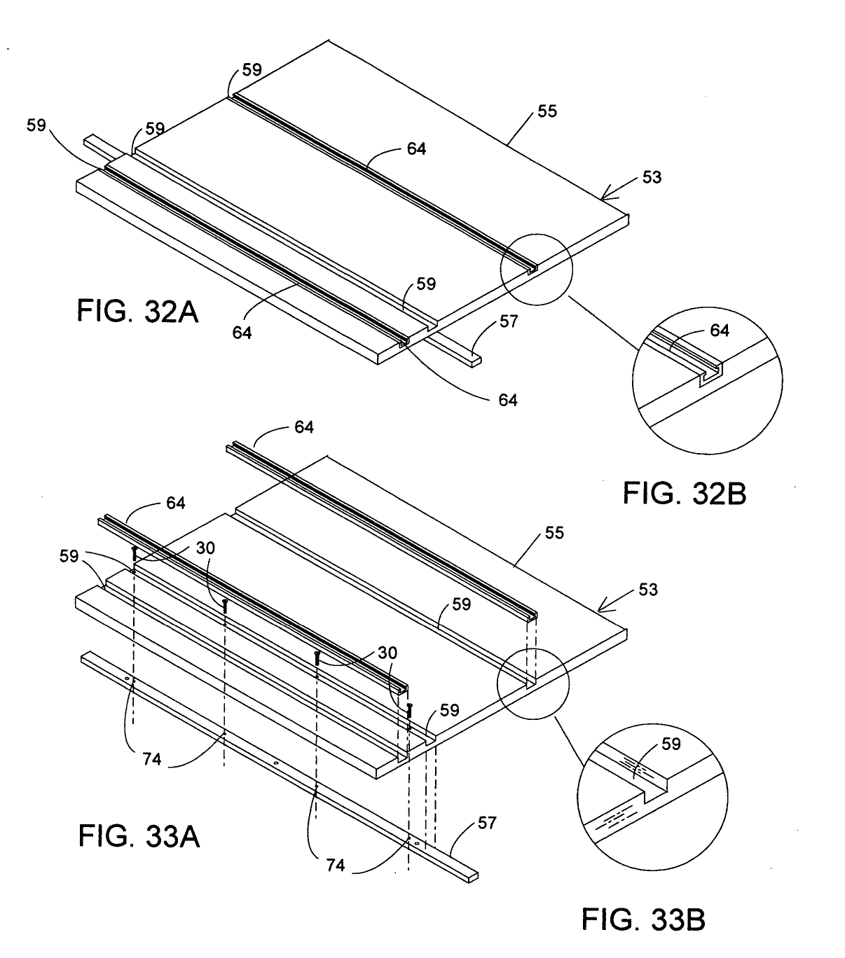

FIG. 32A is a perspective view of the sled 53 with the miter gauge removed showing the three dados 59 cut in the top of the sled platform panel 55 with the fixture bar 57 located under the middle dado 59.

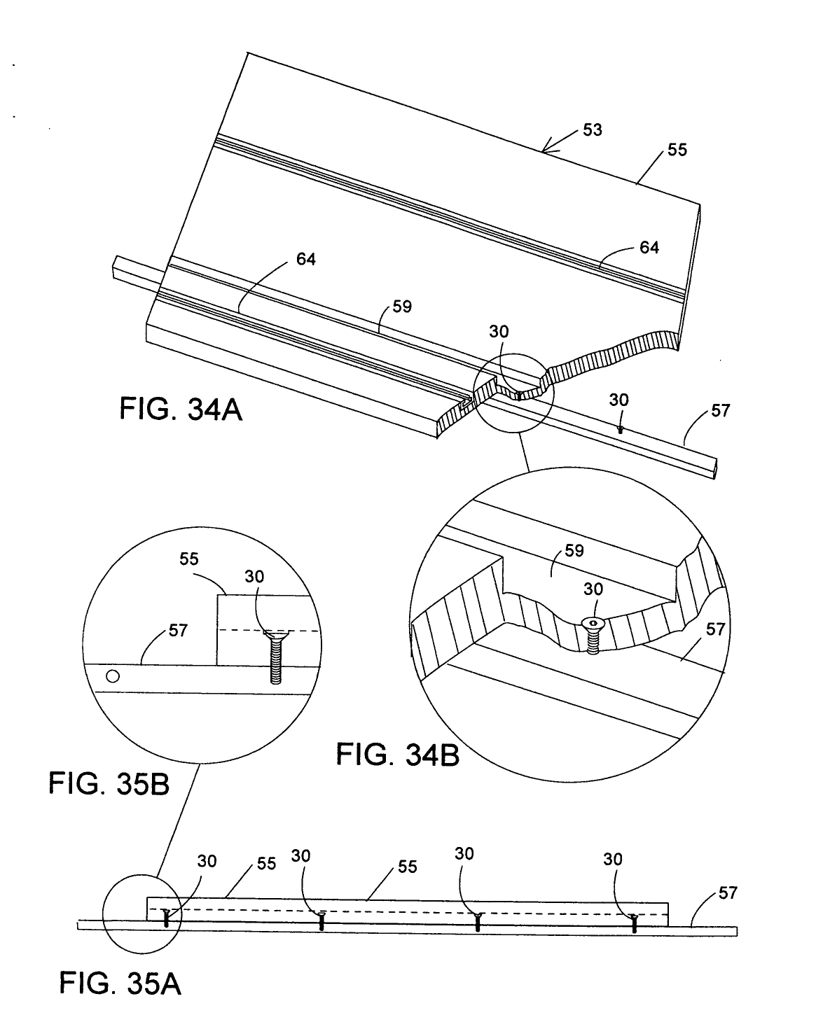

FIG. 34A is a perspective cutaway view and FIG. 34B is an enlargement cutaway view of the dado 59 in the sled platform 55 showing the fixture bar 57 secured to the bottom of the dado 59 with a flat head screw 30. Three vertical through holes 81 are drilled in the miter gauge 10 bar 14 which accept flat head screws 30. The holes 81 extend from the top surface to the bottom surface of the bar 14.

FIG. 34B is an enlargement of FIG. 34A showing the flat head screw 30 in the bottom of the dado securing the fixture bar 57 to the bottom of the sled platform.

FIG. 35A is an elevation view of the sled showing the fixture bar secured to the bottom of the sled platform with flat head screws.

FIG. 35B is an enlargement of FIG. 35A.

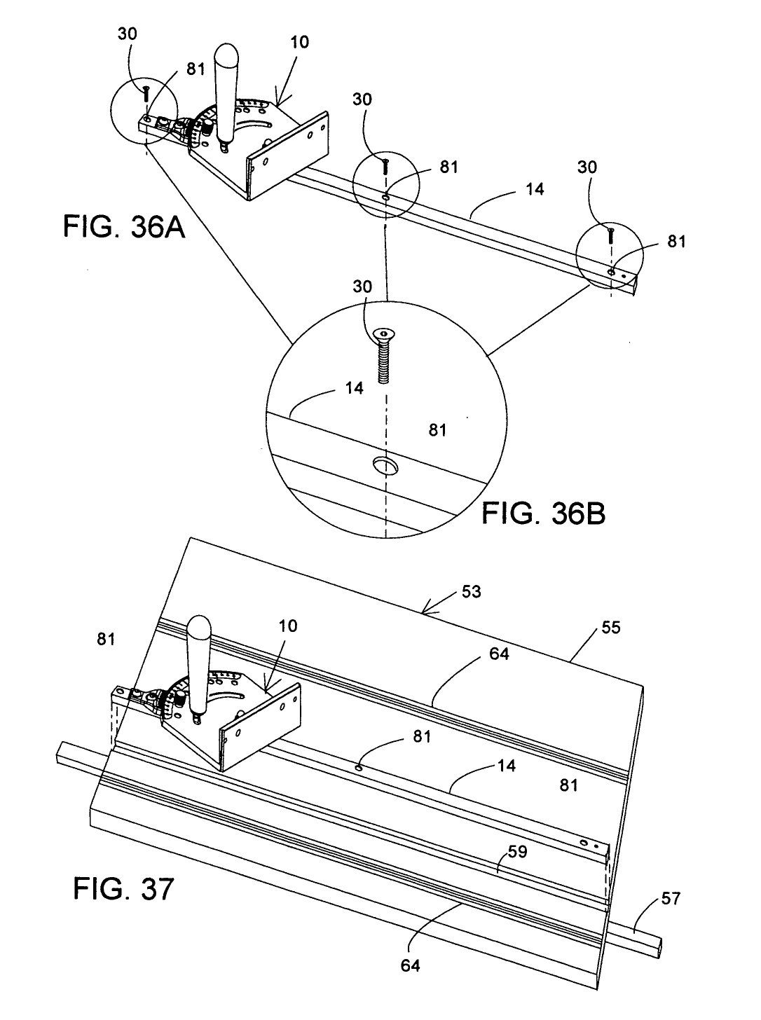

FIG. 36A is a perspective view of the miter gauge showing the three through holes 81 in the bar 14 for securing it to the bottom of the dado in the sled platform 55 with flat head screws 30.

FIG. 36B is an enlargement of FIG. 36A.

FIG. 37 is an exploded perspective view of the miter gauge and the sled.

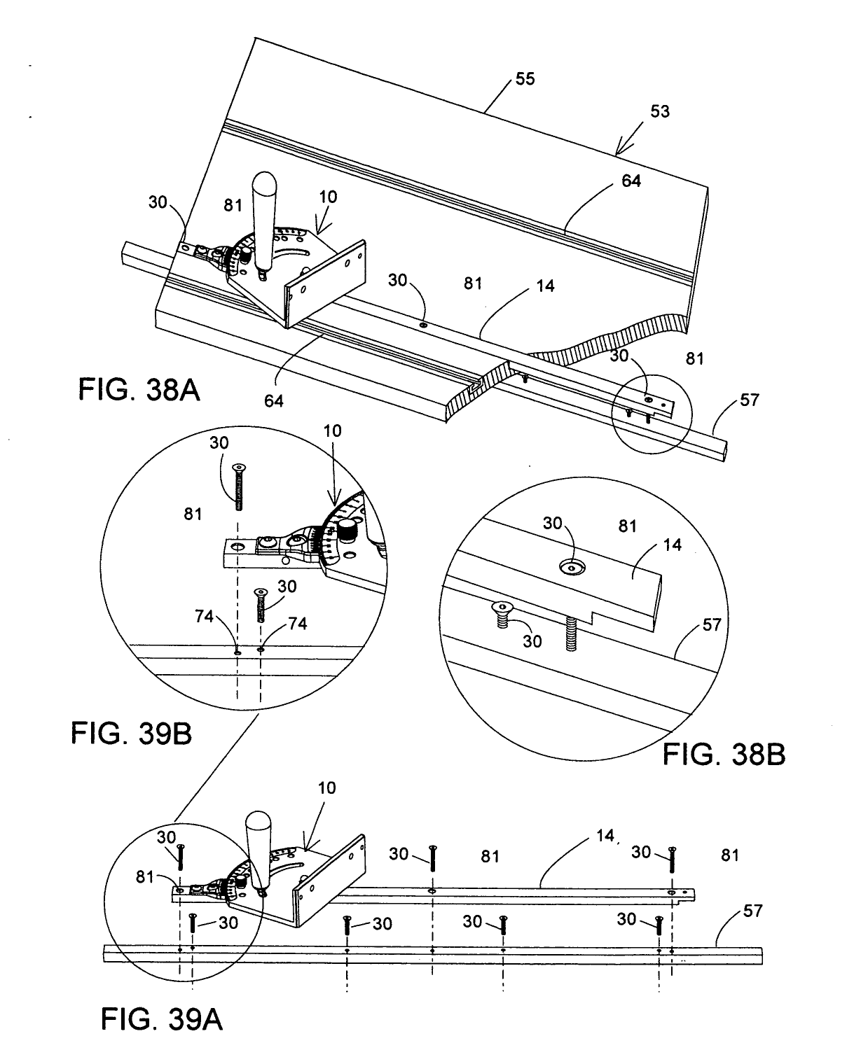

FIGS. 38A, 38B, 39A, and 39B show that the miter gauge 10 is secured to the sled 53 with flat head screws 30 through the miter gauge bar 14 and through the sled platform 55. Also shown are the flat head screws 30 for securing the fixture bar 57 to the bottom of the sled dado 59 and the flat head screws 30 for securing the miter gauge 10 to the fixture bar 57.

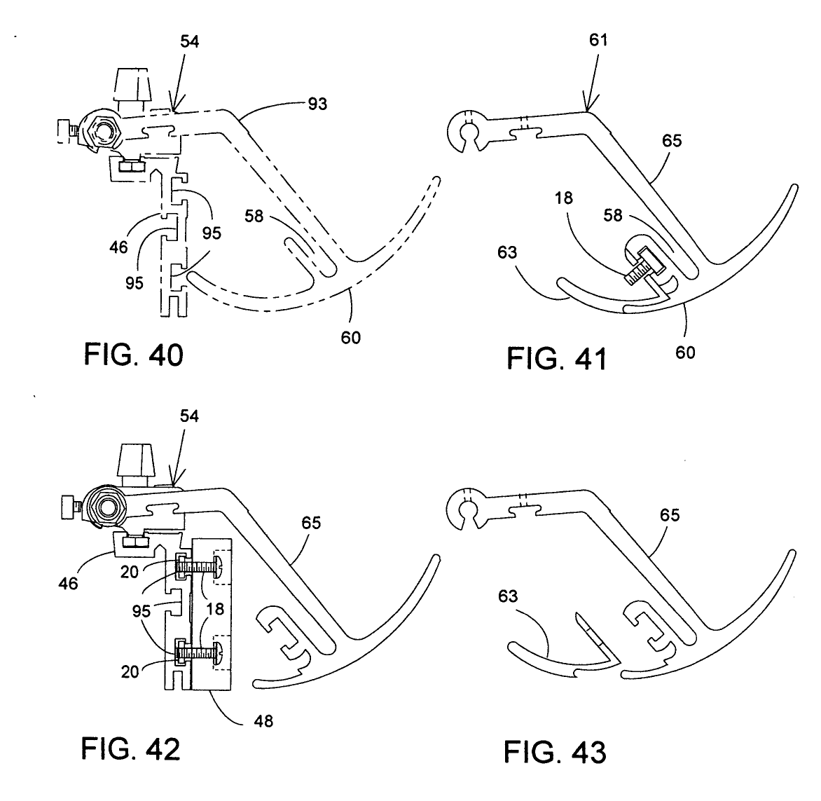

FIG. 40 is an end view of an extruded fence track 46 and the flip stop assembly 54 that are improvements of the flip stop assembly and track of the '966 patent. U.S. patent application Ser. No. 10/944,035 has been filed on this improved track 46 and flip stop assembly 54. The double T-slot on top of the track of U.S. Pat. No. 5,768,966 allows a stop to be moved forward to the front T-slot to make room for a zero-clearance fence 48. A zero-clearance fence 48 is a board that is placed in back of the workpiece 78 and supports the back of the workpiece as it is being cut by the blade 44 thus preventing tearing or chipping of the workpiece 78.

FIG. 41 shows an end view of a two part flip stop 61 with a similar bottom or shoe as the bottom or shoe of the flip stop 93 shown in FIG. 40. The shoe part of the flip arm 61 is made from two parts including the front curved stop extrusion portion 60 with T-slot and arm 65 and the removable flip arm back portion 63, which are held together with a ¼-20 bolt 18. Both the flip stop 93 and the two part flip stop 61 have a fixture mounting slot 58.

FIG. 42 shows the curved stop extrusion with only the front portion including arm 65 replacing the flip stop arm 93 of the flip stop assembly 54, thus allowing room for a zero-clearance fence 48. By discarding the removable rear portion 63 there is now space for a zero-clearance fence 48 secured to the T-slots 95 of the L-shaped fence 46 with ¼-20 bolts 18 threaded into a flat nut 20.

FIG. 43 is an exploded view of the two part flip stop 61 which is made from two parts including the curved front portion 60 of the shoe with arm 65 integral and the removable rear portion 63.

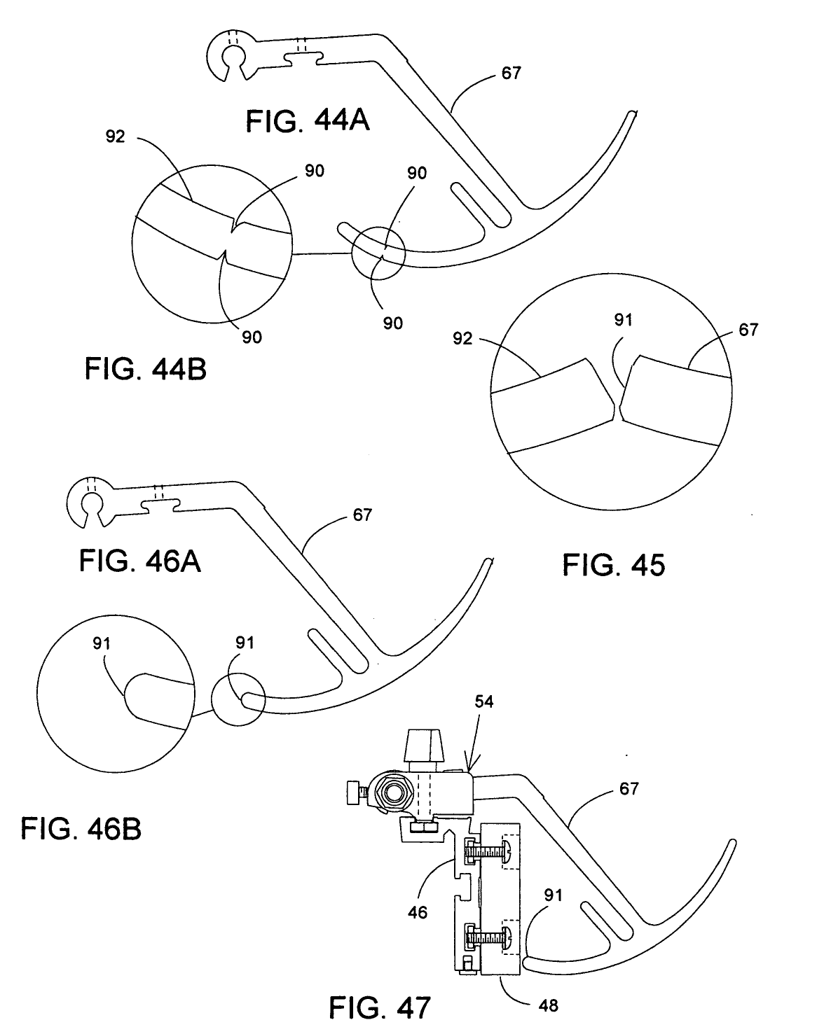

An alternative to the cost of making the two extrusion dies for the two part flip stop 61 shown in FIG. 43 is to modify the existing extrusion die for the curved flip stop extrusion 93. FIG. 44A is an end view of a flip stop with two indentations on the top and bottom of the curved bottom surface of the flip stop. These indentations are markings that create a flip stop with break-away rear portion 92.

FIG. 44B is an enlargement of FIG. 44A showing the two indentations where the extrusion can be broken and thus separating the break-away rear portion 92 from the front portion, which is the remainder of the shoe.

FIG. 45 is an exploded end view of the break-away back two piece flip stop 67 showing it breaking at the indentations 90.

FIG. 46A is an end view of the break-away flip stop 67 with the back tip of front portion 91 rounded.

FIG. 46B is an exploded end view of FIG. 46A.

FIG. 47 is an end view of a flip stop assembly 54 and L-shaped fence shown in FIG. 40 with the flip stop with break-away rear portion 67. With the break-away rear portion 92 removed there is space to add a zero-degree clearance fence 48.

The zero-clearance fence 48 is attached to the front of the track extrusion rather than being an integral part of the track design. Also, the track can be easily extended so that the flip stop assembly 54 can be positioned beyond the length of the original track.

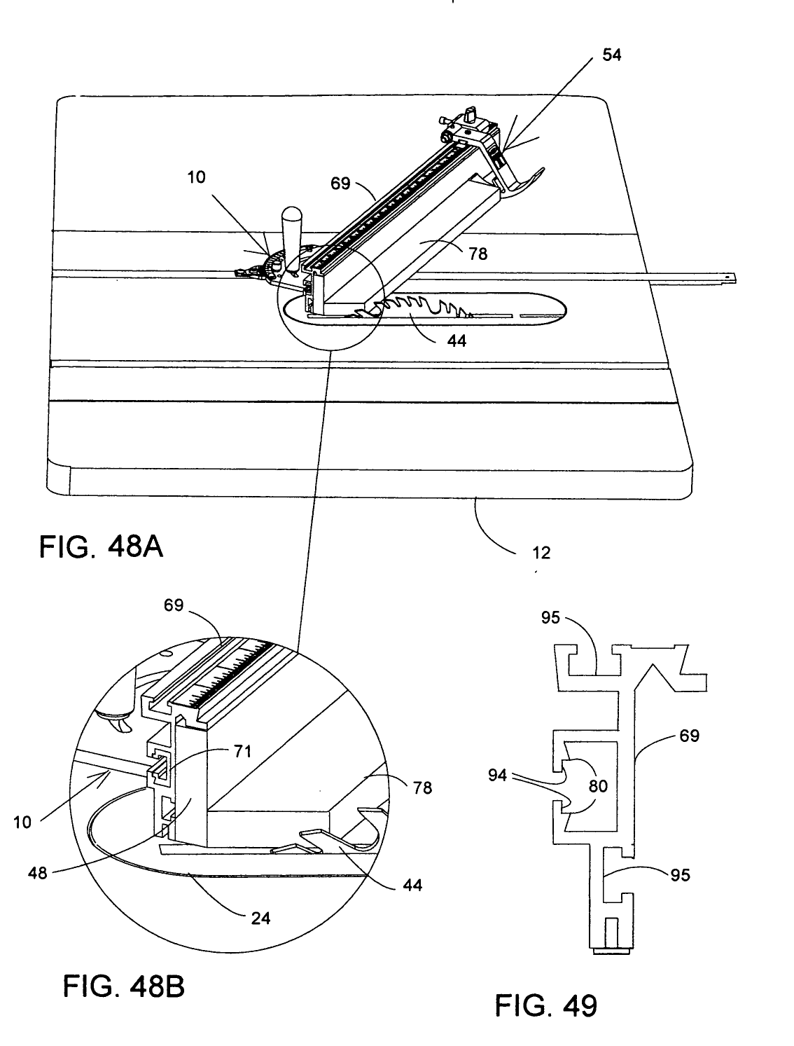

FIG. 48A is a perspective view of the miter gauge with an extruded T-shaped extrusion with modified T-slot 69 and flip stop assembly 54 as it is used on a table saw 12.

FIG. 48B is an exploded view of FIG. 48A showing that the front of the zero clearance fence 48 is aligned with the front of the extruded T-shaped extrusion with modified T-slot 69.

FIG. 49 is an end view of an extruded T-shaped extrusion with modified T-slot 69 fence shown in FIG. 48B. The modified t-slot 94 is designed to accept the head of a ¼-20 bolt 18 in a longitudinal groove that the slot runs through. Inside the modified T-slot 94 are two longitudinally extending wing surfaces or male profiles 80, one on each side of the groove that receives the head of the bolt.

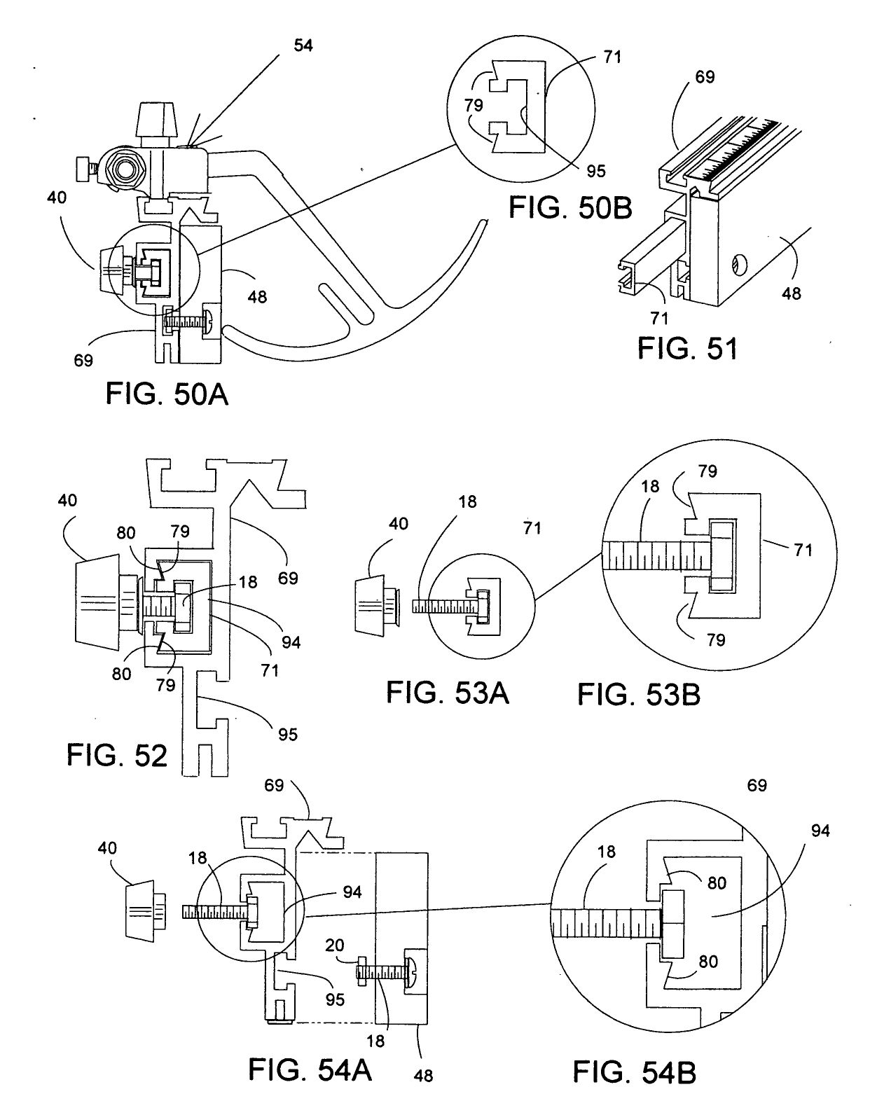

FIG. 50A is an end view of a flip stop assembly 54 and an extruded T-shaped extrusion with modified T-slot 69 shown with a zero clearance fence 48 secured to a T-slot 95 on the front of the extrusion with a ¼-20 bolt 18 and a flat nut 20. In side the modified T-slot 94 is a piece of interlocking minitrack 71. A standard ¼-20 bolt fits inside the T-slot 95 in the interlocking minitrack 71 and secures the interlocking minitrack 71 inside the modified T-slot 94 of the T-shaped extrusion with modified T-slot 69.

FIG. 50B is an exploded end view of the interlocking minitrack 71 showing the T-slot 95 and the longitudinally extending female profile 79.

FIG. 51 is a perspective view of the T-shaped extrusion with modified T-slot 69 shown with a zero-degree clearance fence 48. Inside the modified t-slot 94 is a piece of interlocking minitrack 71 which is secured to the T-shaped fence with a standard ¼-20 bolt (not shown). The interlocking minitrack 71 is shown extended out of the modified T-slot 94 of the T-shaped extrusion with modified T-slot 69. A ruler is received in a groove in the top surface of the horizontal leg of the track 69, forward of the vertical leg. A T-slot is in the horizontal leg rearward of the vertical leg.

FIG. 52 is an enlarged end view of FIG. 50A. with the flip stop assembly 54 and the zero clearance fence 48 removed showing the extruded T-shaped extrusion 69 with modified T-slot 94 shown with a piece of interlocking minitrack 71 inside the modified T-slot 94. A standard ¼-20 bolt fits inside the T-slot 94 in the interlocking minitrack 71 and secures the interlocking minitrack 71 inside the modified T-slot 94 of the T-shaped extrusion with modified T-slot 94. Also shown is the interlocking relationship between the longitudinally extending female profile 79 of the interlocking minitrack 71 and the longitudinally extending male profile 80 of the modified T-slot 94 of the T-shaped extrusion 69.

FIGS. 53A and 53B are end views of the interlocking minitrack 71 with a standard ¼-20 bolt 18 located in the T-slot 95. Also shown is the longitudinally extending female profiles 79 on the side of the interlocking minitrack 71.

FIG. 54A is an end view of the T-shaped extrusion with modified T-slot 69 with the head of a standard ¼-20 bolt 18 captured in the modified T-slot 94 between the two longitudinally extending male profiles 80.

FIG. 54B is an exploded view of FIG. 54A.

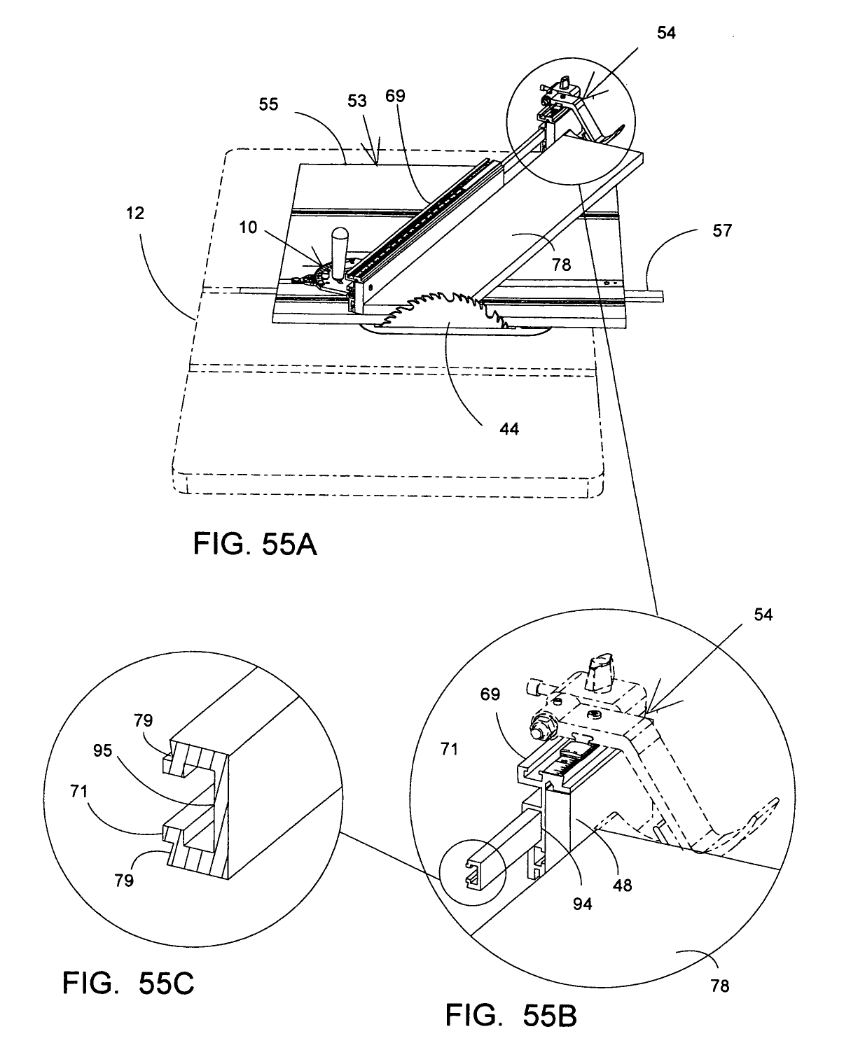

FIG. 55A is a perspective view of the miter gauge with a T-shaped extrusion 69 with modified T-slot fence as it is used on a table saw when secured to a sliding sled 53. An interlocking minitrack 71 is used to secure a short piece of T-shaped extrusion 69 with modified T-slot at the far end of the fence allowing the flip stop assembly 54 to be accurately positioned farther away from the blade than is possible with the standard fence.

FIG. 55B is an exploded view of FIG. 55A showing a cutaway view of the interlocking minitrack 71.

FIG. 55C is an exploded view of FIG. 55B showing an enlarged cutaway view of the interlocking minitrack 71.

Regarding the miter gauge features of the invention, the invention provides an improved system for measuring and cutting angles on woodworking machines such as a tablesaw.

The miter gauge head is an L-shaped aluminum extrusion that is machined to a 5.875″ width with parallel sides. This width decreases the amount of material used and the amount of machining. It also allows the miter gauge to be used on a bandsaw and does not contact the standard tablesaw guard.

This shape, with parallel sides, simplifies the CNC machining process without the need for expensive fixturing. The front face of the miter head, which is the front of the short leg of the L-shaped extrusion, is machined at a 90 degree angle on a CNC milling machine. This guarantees that the face of the miter gauge head is square to the saw table. Machined holes are located in a row for easily cutting frames with 4, 6, 8, and 18 sides. Other frame angles are accurately adjusted by use of the Vernier scale or the 1/100th of a degree adjustment mechanism.

The printed scale is bright yellow for easy visibility with black lines and numbers that are printed 0.007″ in width for very fine adjustment. Red arrows and diamonds accentuate the most commonly used settings. The scale is 0.020″ aluminum with a self-adhesive back that is die cut for ISO 9002 accuracy. This improves the readability of the scale and decreases the cost versus the machined numerals.

The bar line and pointer of the '966 patent are replaced with a full-size modified double Vernier scale. The Vernier scale was developed by the French mathematician Vernier for dividing measurements into decimal fractions. The Vernier scale lines and numbers are printed 0.007″ in width for very fine adjustment. The modified double Vernier scale allows the miter gauge to be very accurately adjusted to 1/10th of a degree in a matter of seconds.

In this application the modified Vernier scale is fitted to an injection-molded plastic (33% glass filled nylon) holder that can be adjusted on the bar so it can be zeroed out to the degree scale on the miter gauge. The modified double Vernier scale and holder are curved to match the miter gauge head. Two button head ¼-20 cap screws secure the Vernier scale to the bar so it is adjustable relative to the bar.

Some tasks, such as cutting odd numbered frames, require setting the miter gauge to an angle adjustable to 1/100th of a degree. For example, cutting a frame with seven sides requires setting the miter gauge accurately to 25.71 degrees. Cutting compound angles also requires unusual angles to be adjustable to 1/100th of a degree. No miter gauge manufactured until now has had 1/100th of a degree adjustability. This new miter gauge was designed to quickly be adjusted to 1/100th of a degree using ordinary shop tools such as a feeler gauge or dial caliper.

The machined head is 5.875″ wide with parallel sides. A step is machined 0.100″ deep from the face and 0.073 wide from the corner. By machining the step in each corner of the machined face of the miter gauge head is reduced to 5.729″ wide. The number (5.729) is significant as a trigonometric calculation for the 1/100th of a degree adjustment.

Two bolts located in the two holes secure the fence extrusion to the machined surface of the miter gauge head. Two ¼-20 set screws are located in a threaded hole aligned with the bolts and located near the edge of the miter face. The set screws can be used to microadjust one side of the fence extrusion away from the machined head. As the fence extrusion is microadjusted, the distance between the head and the fence extrusion can be measured using a dial caliper. Every 0.001″ read on the dial caliper equals 1/100 of a degree.

A variation of the design is a machined aluminum angle with the same size machined surface that is 5.875″ wide with parallel sides. A step is machined 0.100″ deep from the face and 0.073 wide from the corner. By machining the step in each corner the machined face of the miter gauge head is reduced to 5.729″ wide. The number (5.729) is significant as a trigonometric calculation for 1/100th of a degree adjustment.

There are miter gauges now available which have a stamped angle. An aftermarket machined head as described above is more accurate than a stamping piece and provides the user with the fence microadjust option of using a dial caliper or a feeler gauge to microadjust the fence for improved accuracy.

To accurately measure small changes in the angle of the fence extrusion, the angle adjustment is represented in thousandths of an inch so it can be measured with the feeler gauge or caliper. In this situation, the ideal scenario is to have the thousandth of an inch of measurement represent 1/100th of a degree of fence adjustment.

It has been a common practice when working with a table saw for the user to make a sliding sled which is a sliding platform with a runner that fits into the miter slot. The sled has the advantage of supporting the board from below as it is advanced into the table saw blade during the saw cut. The sliding sled has the advantage over the miter gauge of providing better support for large boards which can bind even with the miter gauge reversed in the miter slot. The sled is also advantageous for cutting small pieces because these delicate pieces can be clamped to the sled platform and safely moved into the blade.

The sled platform also provides a zero-clearance support under the workpiece preventing tear out and chipping on the bottom of the board. The miter gauge of this invention provides an optional sled design to which the miter gauge can be secured in less than a minute. The optional sled is a platform with two pieces of minitrack, one on each side, and a dado in the middle in which the miter gauge can be secured quickly to a bar on the bottom of the sled that slides in the table saw miter gauge slot.

A flip arm stop design with a removable back allows space for a zero-clearance board on the front of an L-shaped fence extrusion. A T-shaped fence extrusion with a built in zero-clearance board has a modified T-slot with an interlocking minitrack which allows the fence to be extended and secured with the standard ¼-20 bolt without the need for any machining.

A preferred embodiment of the invention has been described in considerable detail. Many modifications and variations to the preferred embodiment described will be apparent to a person of ordinary skill in the art. Therefore, the invention should not be limited to the embodiment described.

1. In a miter guide for guiding a workpiece into a cutting tool having a miter bar and a miter head pivotally connected to the miter bar, with an angle between the miter head and the miter bar being adjustable so as to vary the angle that the workpiece is fed into the cutting tool, the improvement wherein the miter head has a miter head angle scale fixed to it and the miter bar has a Vernier angle scale fixed to it, said Vernier scale having a set of indicia positioned at at least three positions that are aligned with a corresponding number of indicia on the miter head angle scale when the miter head is at a 0° position relative to the miter bar.

2. A miter guide as claimed in claim 1, wherein there are at least five positions that are aligned with a corresponding number of indicia on the miter head angle scale when the miter head is at a 0° position relative to the miter bar.

3. A miter guide as claimed in claim 1, wherein there are distinguishing indicia on the miter head angle scale at the at least three positions that distinguish those positions from other indicia on the miter head angle scale.

4. A miter guide as claimed in claim 3, wherein the distinguishing indicia include diamond shapes.

5. A miter guide as claimed in claim 1, wherein there are distinguishing indicia on the miter bar angle scale at the at least three positions that distinguish those positions from other indicia on the miter bar angle scale.

6. A miter guide as claimed in claim 1, wherein there are distinguishing indicia on the miter bar angle scale at the at least three positions that distinguish those positions from other indicia on the miter bar angle scale and there are distinguishing indicia on the miter head angle scale at the at least three positions that distinguish those positions from other indicia on the miter head angle scale, and the distinguishing indicia on both scales at the at least three positions correspond to one another.

7. A miter guide as claimed in claim 1, wherein the miter bar angle scale is adjustably fixed to the miter bar.

8. A miter guide as claimed in claim 1, wherein sides of the miter head are parallel.

9. A miter guide as claimed in claim 1, wherein the miter head and miter bar angle scales are printed together as a unit and subsequently thereafter separated with a die cut to assure that the indicia at the at least three positions on the two scales are aligned with one another.

10. A miter guide as claimed in claim 1, wherein the miter head angle scale is received in a groove in the miter head that locates the scale relative to the miter head.

11. A miter guide as claimed in claim 1, wherein the Vernier scale is received in a groove of a Vernier scale holder that is adjustably affixed to the miter bar.

12. In a miter guide for guiding a workpiece into a cutting tool having a miter bar and a miter head pivotally connected to the miter bar, with an angle between the miter head and the miter bar being adjustable so as to vary the angle that the workpiece is fed into the cutting tool, the improvement wherein the miter head has a miter head angle scale fixed to it and the miter bar has a Vernier angle scale fixed to it, wherein the Vernier scale is adjustably affixed to the miter bar.

13. A miter guide as claimed in claim 10, wherein the Vernier scale is received in a groove of a Vernier scale holder that is adjustably affixed to the miter bar.

14. In a miter guide for guiding a workpiece into a cutting tool having a miter bar and a miter head pivotally connected to the miter bar, with an angle between the miter head and the miter bar being adjustable so as to vary the angle that the workpiece is fed into the cutting tool, the improvement wherein the miter head has a miter head angle scale fixed to it and the miter bar has a Vernier angle scale fixed to it, wherein the Vernier scale is a double Vernier scale having Vernier angle scale markings on both sides of a 0° position.

15. In a miter guide for guiding a workpiece into a cutting tool having a miter bar and a miter head, the miter head having a front face against which a fence can be secured, the improvement wherein the front face has vertically extending edges at opposite ends spaced a certain distance apart so that the fence can be angled relative to the front face with one edge of the front face acting as a fulcrum against the fence and the spacing between the other edge and the fence measured and converted to an angle with a certain known relationship between the measured spacing and the angle.

16. A miter guide as claimed in claim 15, wherein the spacing between the edges is approximately 5.729 inches.

17. A miter guide as claimed in claim 15, wherein at least one end of the miter head has a ledge spaced a certain distance back from one of the edges such that a measurement of the spacing can be made between the ledge and the fence to determine the spacing of the fence from the edge.

18. A miter guide as claimed in claim 15, wherein the ledge is spaced back 0.1 inches from the edge.

19. A miter guide as claimed in claim 15, wherein each end of the miter head has a ledge spaced a certain distance back from one of the edges such that a measurement of the spacing can be made between the ledge and the fence to determine the spacing of the fence from the edge.

20. A miter guide as claimed in claim 15, wherein the fence has a T-slot in a rear surface in which heads of bolts that extend through the front surface of the miter head are slidably received, and at least one adjustment screw extends from the front face of the miter head that can be turned to adjust the angle of the fence to the front face of the miter head.

21. In a miter guide for guiding a workpiece into a cutting tool having a miter bar and a miter head, the miter bar having top and bottom surfaces and opposite side surfaces, the improvement wherein the miter bar has holes that extend between the top and bottom surfaces of the miter bar.

22. A miter guide as claimed in claim 21, wherein there are at least three holes.

23. A miter guide as claimed in claim 21, further comprising a sled platform, wherein the miter bar is received in a groove in an upper surface of the sled platform.

24. A miter guide as claimed in claim 23, further comprising a fixture bar fixed to the sled platform below the sled platform and aligned with the miter bar.

25. A miter guide as claimed in claim 23, further comprising at least one T-slot in the upper surface of the sled platform.

26. A miter guide as claimed in claim 23, further comprising at least one T-slot in the upper surface of the sled platform on each side of the miter bar.

27. In a stop for a jig and fixture system having a work support that defines a working plane and a stop for guiding a workpiece supported by the work support to position the workpiece relative to a tool, the stop having an arm and a shoe, with the arm attached to the shoe and the shoe extending forwardly and rearwardly of the arm, the improvement wherein the shoe has a forward portion and a rearward portion, and the rearward portion is removable from the forward portion.

28. A stop as claimed in claim 27, wherein the arm is attached to the forward portion of the shoe.

29. A stop as claimed in claim 27, wherein an intersection between the rearward portion and the forward portion is marked and the rearward portion is removable from the forward portion by breaking the rearward portion off from the forward portion at the mark.

30. A stop as claimed in claim 27 wherein the rearward portion is attached to the forward portion by a removable fastener.

31. A stop as claimed in claim 27, wherein the rearward portion is attached to the forward portion by a removable fastener received in a T-slot of one of the portions.

32. A stop as claimed in claim 27, wherein the rearward portion is attached to the forward portion by a removable fastener received in a T-slot in the forward portion.

33. A stop as claimed in claim 27, wherein the stop is a flip stop.

34. In a track for a jig and fixture system of the type along which jigs and fixtures may be adjustably secured, the improvement wherein said track has a generally T-shaped cross-sectional shape, having a first leg with a front side and a rear side and a second leg connected to one end of said first leg at a right angle, said second leg extending forwardly and rearwardly from said first leg and having a top side and a bottom side, said track having a longitudinal T-slot on the top side of the second leg.

35. A track as claimed in claim 34, wherein the T-slot is in a portion of the second leg that extends rearwardly of the first leg.

36. A track as claimed in claim 34, wherein a ruler is on a portion of the second leg that extends forwardly from the first leg.

37. A track as claimed in claim 34, wherein a T-slot is positioned in a forwardly facing surface of the first leg.

38. A track as claimed in claim 34, wherein a T-slot is positioned in a rearwardly facing surface of the first leg.

39. A track as claimed in claim 34, wherein a T-slot in a rearwardly facing surface of the first leg is a modified T-slot having a central slot, ledges inside the T-slot adjacent to the central slot that can support the underside of the head of a fastener and angled wing surfaces outward of the ledges.

40. A track as claimed in claim 39, further comprising a minitrack that fits in the modified T-slot with angled surfaces that mate with the angled wing surfaces of the modified T-slot and having a T-slot to receive the head of a fastener.

41. A track as claimed in claim 40, wherein two of the T-shaped tracks are connected by the minitrack.
